(19) United States
(12) Patent Application Publication
(10) Pub. No.: US 2023/0189380 A1
(43) Pub. Date: Jun. 15, 2023

(54) SMALL DATA EXCHANGE HANDLING BY A USER EQUIPMENT IN INACTIVE STATE

(71) Applicant: Intel Corporation, Santa Clara, CA (US)

(72) Inventors: Sudeep PALAT, Cheltenham (GB); Marta MARTINEZ TARRADELL, Hillsboro, OR (US); Sangeetha L. BANGOLAE, Portland, OR (US); Alexander SIROTKIN, Hod Hasharon (IL); Ansab ALI, Hillsboro, OR (US); Seau Sian LIM, Swindon (GB); Youn Hyoung HEO, San Jose, CA (US); Richard BURBIDGE, Shrivenham Oxfordshire (GB)

(21) Appl. No.: 17/925,441

(22) PCT Filed: Jul. 27, 2021
(86) PCT No.: PCT/US2021/071020

§ 371 Date: Nov. 15, 2022

Related U.S. Application Data
(60) Provisional application No. 63/058,378, filed on Jul. 29, 2020.

(51) Int. Cl. H04W 76/20; H04W 76/30

(52) U.S. Cl. CPC H04W 76/20; H04W 76/30

(57) ABSTRACT

Various embodiments herein provide techniques for small data transmission of a user equipment (UE) in a radio resource control (RRC) inactive state. The techniques may be used with a next generation Node B (gNB) that employs a distributed unit (DU)/centralized unit (CU) split. The DU receives, from the UE in the RRC inactive state, data and processing information for processing for the data, processes the data based on a radio link control (RLC) bearer, and sends the processed data to the CU.

### CROSS REFERENCE TO RELATED APPLICATION

The present application claims priority to U.S. Provisional Patent Application No. 63/058,378, which was filed 29 Jul. 2020; the disclosure of which is hereby incorporated by reference.

### FIELD

Various embodiments generally may relate to the field of wireless communications.

### BACKGROUND

A user equipment (UE) generally needs to transition into RRC_CONNECTED to send any uplink (UL) data. In some of the latest enhancements for Long Term Evolution (LTE) and discussion in New Radio (NR), a UE can send a single packet/protocol data unit (PDU) while UE is in RRC_IDLE with suspend indication or in RRC_IDLE. However, there is no mechanism defined or discussed for a UE in RRC_INACTIVE to exchange multiple packets/PDUs of data (e.g. without having to always transition the UE into RRC_CONNECTED) considering also the NR centralized unit (CU)/distributed unit (DU) architecture.

### BRIEF DESCRIPTION OF THE FIGURES

FIG. 1 illustrates a transition procedure from a radio resource control (RRC) inactive state to another RRC state in accordance with Figure 8.6.2-1 of 3GPP Technical Standard (TS) 38.401, V16.2.0.

FIG. 2 illustrates a transition procedure from the RRC inactive state to a RRC connected state in accordance with Figure 8.9.6.2-1 of TS 38.401.

FIG. 3 illustrates a transition procedure for RRC connected state to RRC inactive state in accordance with Figure 8.6.1-1 of TS 38.401.

FIG. 4 illustrates a transition procedure for RRC connected state to RRC inactive state in accordance with Figure 8.9.6.1-1 of TS 38.401.

FIG. 5 illustrates an uplink (UL) transmission from a UE in inactive state to a DU that triggers a new small data transmission (SDT) mechanism in accordance with various embodiments.

FIG. 6 illustrates a SDT process that retains user context and radio link control (RLC) bearers in the DU while UE is in RRC inactive state, wherein a first UL message includes a resume request and data, in accordance with various embodiments.

FIG. 7 illustrates a SDT process that retains user context and RLC bearers in the DU while UE is in the RRC inactive state, wherein a first UL message only includes the data and optionally user plane (UP) information (e.g., a medium access control (MAC) control element (CE)).

FIG. 8 illustrates a SDT process while the UE is in inactive state, in which user data is temporarily stored at the DU, in accordance with various embodiments.

FIG. 9 illustrates downlink (DL) signaling using MAC to provide security information (e.g., non-orthogonal cover code (NCC)), in accordance with various embodiments.

FIG. 10 illustrates an SDT process that includes creating an RLC bearer using default configuration on receipt of a “Resume Request & Data” message, in accordance with various embodiments.

FIG. 11 illustrates an example MAC CE that may be used in the process of FIG. 10, in accordance with various embodiments.

FIG. 12 illustrates an SDT process that includes providing UE-specific SDT configuration in a resume request while the UE is in the inactive state, in accordance with various embodiments. For example, a first UL message may include the RRC Resume Request, data, and required SDT configuration in MAC CE, header, or RRC message.

FIG. 13 illustrates a SDT process that includes creating an RLC bearer on receipt of a “Resume Request & Data” message and handling multiple UL data transmissions while UE is in the RRC inactive state, in accordance with various embodiments.

FIG. 14 illustrates a process including user data sent to a CU control plane (CU-CP) before being forwarded to a CU user plane (CU-UP), in accordance with various embodiments.

FIG. 15 illustrates a process including use of an end marker to indicate to the DU that there is no further DL data, in accordance with various embodiments.

FIG. 16 illustrates an example CU region including multiple DUs, in accordance with various embodiments.

FIG. 17 illustrates a process including user data sent to a DU that is not directly connected to the CU-CP and/or CU-UP that were serving the UE before the UE was released to the inactive state, in accordance with various embodiments. The second forwarded data may be DL data in some embodiments.

FIG. 18 illustrates a network in accordance with various embodiments.

FIG. 19 schematically illustrates a wireless network in accordance with various embodiments.

FIG. 20 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 21-23 illustrate example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein may enable a UE in “RRC_INACTIVE” to exchange data or signaling (e.g. without having to transition the UE into RRC_CONNECTED), considering NR CU/DU architecture. For example, some features of various embodiments may include:
New mechanisms for a UE in INACTIVE exchanging data when DU and CU are not co-located focusing on the handling of the UE's configuration and UE's radio link control (RLC) bearer associated with the resume/suspend procedures.
New mechanism for a UE in INACTIVE exchanging data when UE access stratum (AS) Context is available in a given CU region.

The proposed solutions enable a UE to send data while in RRC_INACTIVE when DU and CU may or may not be co-located.

Aspects of various embodiments may be adopted into future versions of one or more Third Generation Partnership Project (3GPP) Technical Standards (TSs), such as TS 38.300, 38.331, and/or 38.321.

### 1.1 General Principles Applicable to the Disclosure

The following principles may apply to various embodiments described in this disclosure:
The embodiments described herein are applicable for 4-step based random access channel (RACH) procedure and 2-step based RACH procedure.
Some embodiments may be described under the assumption that an UL small data transmission (SDT) is first triggered. However, the embodiments may be equally applicable when DL SDT triggers the initiation.
The new mechanisms described here enable transmission of N transmissions of UL SDT and M transmissions of DL SDT while keeping UE in INACTIVE, where N and M could be any integer number greater or equal to 1.
The UL or DL SDT refers to both data or signaling (including e.g. medium access control (MAC) control elements (CEs) or radio resource control (RRC) messages) that are exchanged between the UE and network. Therefore, SDT mechanism assumes that it is possible to multiplex any signaling (e.g., sent over signaling radio bearer (SRB) SRB0, SRB1 or SRB2) and/or data (sent over any data radio bearer (DRB)).
Some embodiments may be described with the assumption that UE AS context is successfully relocated to the new next generation Node B (gNB). However, embodiments may be equally applicable when the UE AS context does not need to be relocated. Moreover, in some cases the interactions with previous gNB and access and mobility management function (AMF) may not be shown for simplicity to focus on the radio interface aspects.
The new mechanisms described here are described with reference to allowing SDT while UE is in RRC_INACTIVE. However it should be possible at any time for the UE to transition into RRC_CONNECTED when falling back to resume a RRC connection and to establish a new RRC connection.
Embodiments may be described as using RRC signaling (e.g. RRCResumeRequest and RRCRelease) when exchanging the SDT. However, similar operation could also be enabled without this RRC signaling, such as, when UE is accessing in the cell where the UE AS Context was stored (which here is referred as “last gNB” but may also be referred as “anchor gNB”).
All or part of the mechanisms and options described herein may be enabled jointly or in any combination together. Moreover, the new operations described for one of the embodiments may be equally applicable to the other solutions and options described here.

### 1.2 Resume/Suspend Procedures Considering CU/DU Split (Legacy NR Operation)

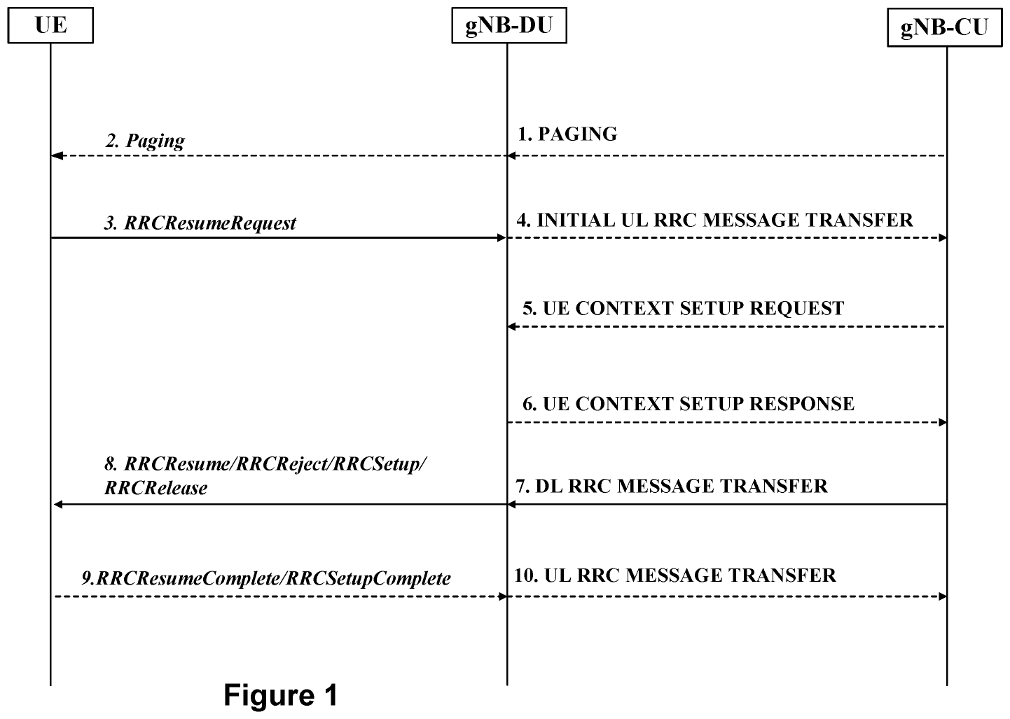

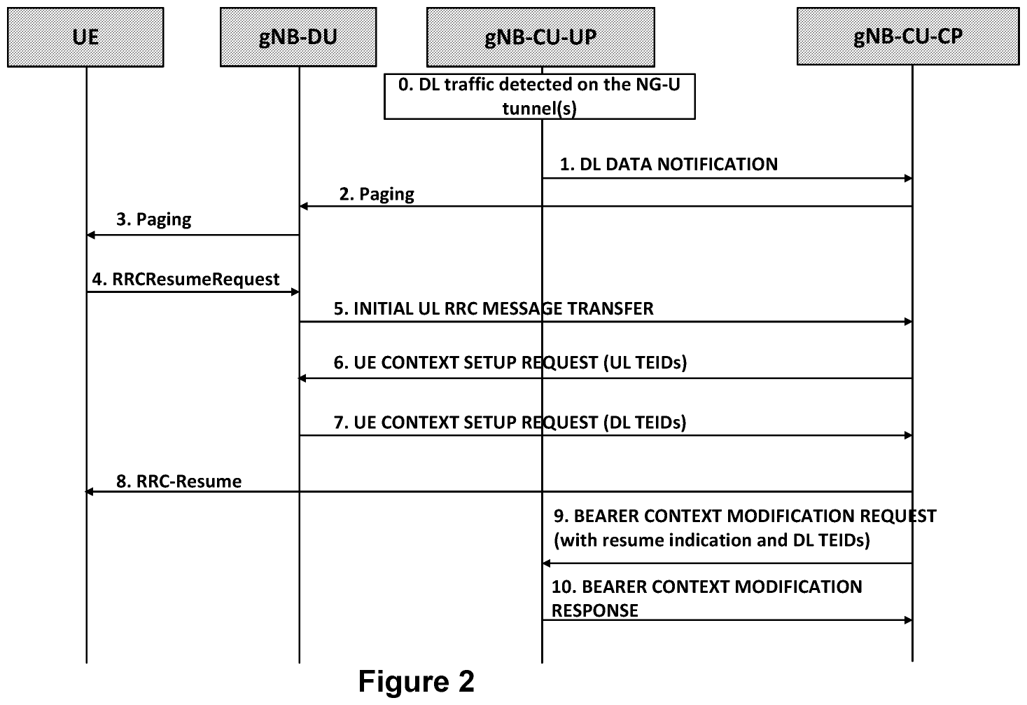

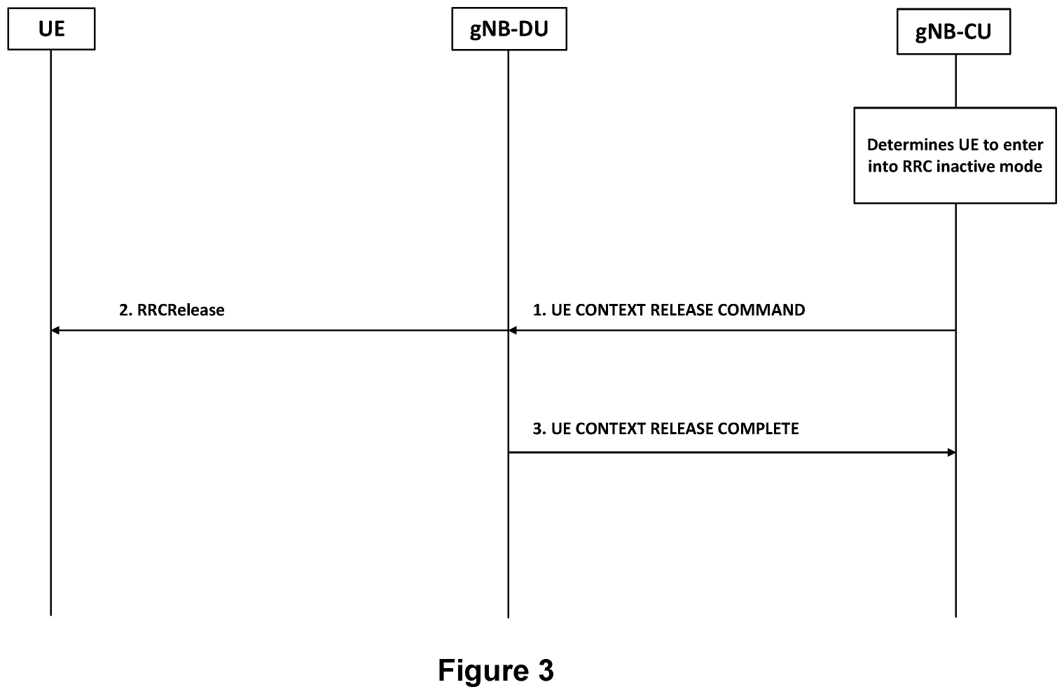

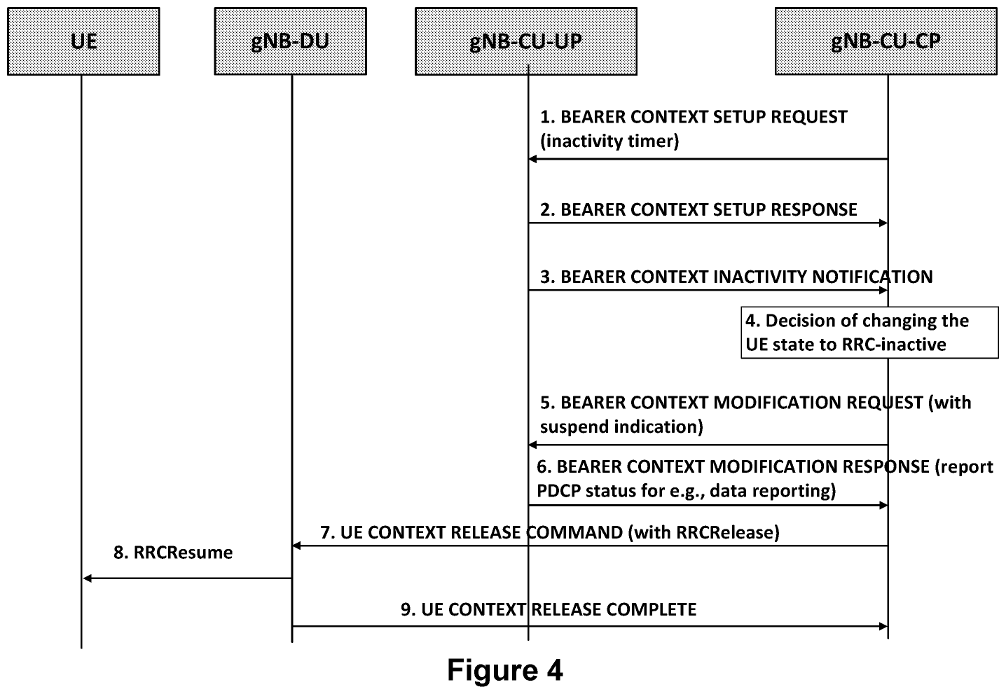

FIG. 1 and FIG. 2 summarize the resume procedure of an NR UE connected to 5GC. FIG. 3 and FIG. 4 summarize the release procedure of an NR UE connected to 5G core network (5GC) to transition into RRC_INACTIVE, also referred to as suspend procedure. Further detail is found in 3GPP TS 38.401, V16.2.0.

1.3 New mechanisms for a UE in INACTIVE exchanging data when DU and CU are not co-Located:

When the UE goes to INACTIVE, in legacy networks, all of the UE context is released in the DU. That is, the DU no longer has an instance of the user's logical channels, the configuration for the physical/MAC layers or any of the RLC bearers of the DRB(s) and SRB(s) or the configurations provided by the CU.

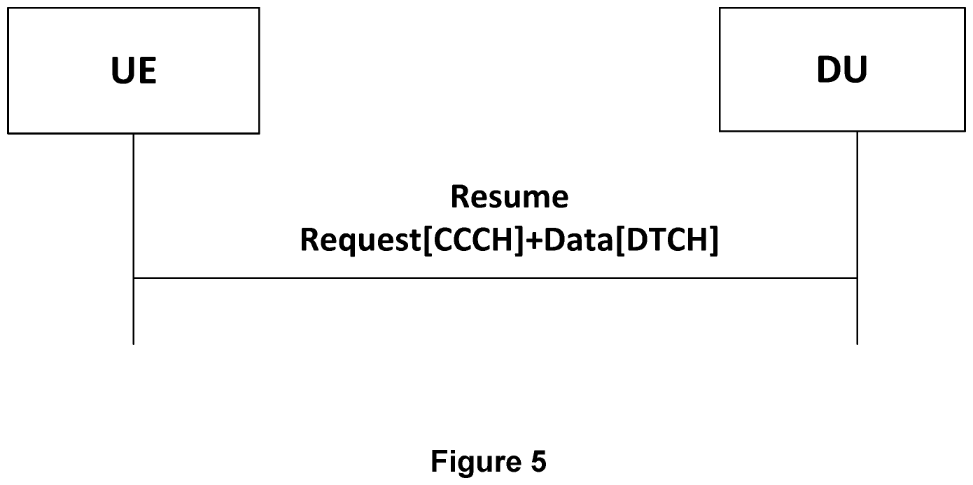

For small data transmission (SDT), msg A or msg3 carries Resume Request+user data as shown in FIG. 5. Resume Request is sent over the Common control channel (CCCH) using a default configuration and RLC transparent mode. This request message can be processed directly by the DU without any additional information. User data is sent over dedicated traffic channel (DTCH) and has to be processed by a user's DRB. Since there is no UE context available at the DU nor any instance of the logical channels, the DU cannot process this data directly. There are few new options possible on how to handle this small data sent after performing RACH (referred to as ‘SDT-RACH’) at the DU as explained below. The key aspects considered are the following:
A. The handling of the UE's configuration associated with the resume/suspend procedures during SDT-RACH mechanism considering CU/DU architecture (note that a mix of option (a) and (b) could also be considered):
   Approach A.1. Default or known UE's configurations (e.g. pre-defined in specification or provided by gNB via SI) are used for UE's SDT-RACH.
   Approach A.2. Configurations stored in the UE Inactive AS Context are used for UE's SDT-RACH.
B. The handling of UE's RLC bearer with the resume/suspend procedures during SDT-RACH mechanism considering CU/DU architecture:
   Approach B.1. RLC bearer is resumed/suspended after each SDT.
   Approach B.2. RLC bearer is retained while UE is in RRC_INACTIVE (including the UP).
      Option 1) Retain the User Context and RLC Bearers in the DU while UE is in INACTIVE.

In this option, the user context and RLC bearers are retained in the DU even when the UE is INACTIVE. This is only useful if the UE sends SDT in the same cell as the one in which it was released.

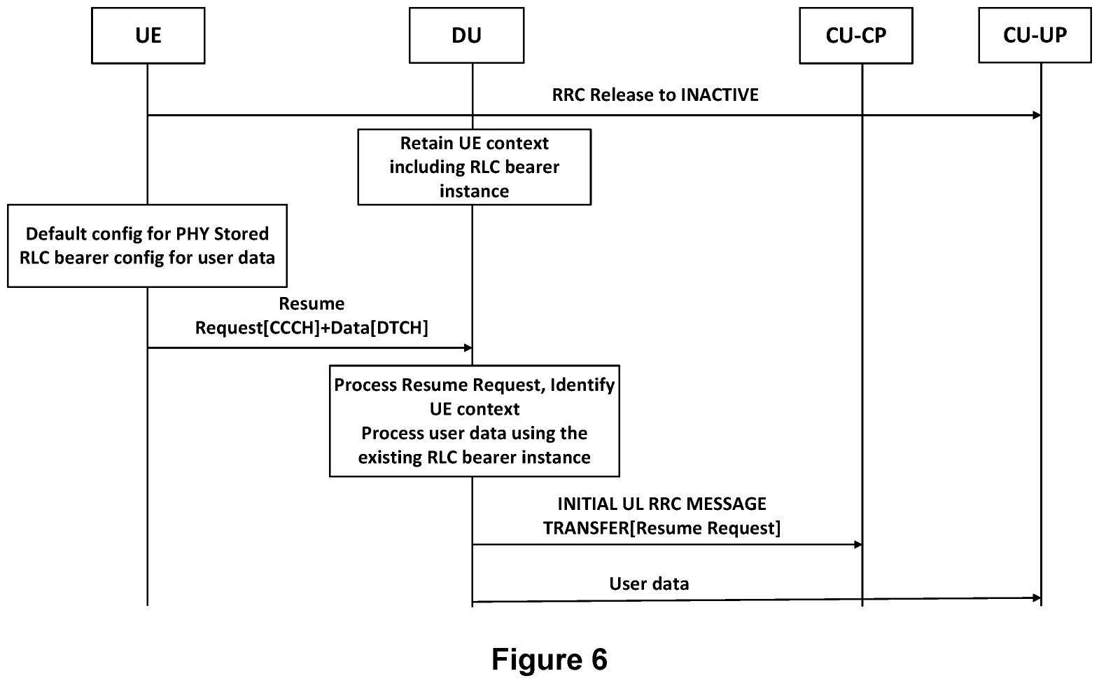

This allows the user data to be processed immediately by the appropriate RLC bearer instance. This is shown in the FIG. 6 with the assumption that the Pt UL message includes a resume request and the data.

F1-AP signaling can be enhanced to allow the CU to control whether the DU keeps the UE context when receiving the UE Context Release Command, for example by adding a flag to this message as shown below. Exemplary update of the UE CONTEXT RELEASE COMMAND is shown below with the changes underlined and bolded.

9.2.2.5 UE Context Release Command

This message is sent by the gNB-CU to request the gNB-DU to release the UE-associated logical F1 connection.

Direction: from gNB-CU to gNB-DU

| | | | | | | |
|---|---|---|---|---|---|---|
| | | | IE type | | | |
| | | | and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| gNB-CU UE F1AP | M | 9.3.1.4 | | YES | reject |
| ID | | | | | |
| gNB-DU UE F1AP | M | 9.3.1.5 | | YES | reject |
| ID | | | | | |
| Cause | M | 9.3.1.2 | | YES | ignore |
| RRC-Container | O | 9.3.1.6 | Includes the | YES | ignore |
| | | | DL-DCCH- | | |
| | | | Message IE | | |
| | | | as defined in | | |
| | | | subclause 6.2 | | |
| | | | of TS 38.331 | | |
| | | | [8] encapsulated | | |
| | | | in a PDCP PDU, | | |
| | | | or the DL-CCCH- | | |
| | | | Message IE as | | |
| | | | defined in | | |
| | | | subclause 6.2 | | |
| | | | of TS 38.331 | | |
| | | | [8]. | | |
| SRB ID | C- | 9.3.1.7 | The gNB-DU | YES | ignore |
| | ifRRCContainer | | sends the RRC | | |
| | | | message on the | | |
| | | | indicated SRB. | | |
| old gNB-DU UE | O | 9.3.1.5 | Include it if | YES | ignore |
| F1AP ID | | | RRCReestablish- | | |
| | | | mentRequest | | |
| | | | is not accepted | | |
| Execute Duplication | O | ENUMERATED | This IE may be | YES | ignore |
| | | (true, . . .) | sent only if | | |
| | | | duplication has | | |
| | | | been configured | | |
| | | | for the UE. | | |
| RRC Delivery Status | O | ENUMERATED | Indicates | YES | ignore |
| Request | | (true, . . .) | whether RRC | | |
| | | | DELIVERY | | |
| | | | REPORT | | |
| | | | procedure is | | |
| | | | requested for | | |
| | | | the RRC | | |
| | | | message. | | |
| Keep UE Context | O | ENUMERATED | Indicates | YES | ignore |
| | | (true, . . .) | whether the | | |
| | | | gNB-DU shall | | |
| | | | keep the UE | | |
| | | | context. | | |

Instead of an RRC Resume request, the UE context identification can be carried in the user data header or as other user plane information, such as MAC CE. A UE DU context identifier is provided to the UE, which could be I-RNTI (e.g. resume ID) or another new ID. On receipt of the Resume Request with information about the UE DU context ID, the DU identifies the UE context in the DU and the associated RLC bearer instances. After the UE context and the associated RLC bearer instances are identified, the processing in the DU on receipt of the msgA/msg 3 containing user data is similar to the regular processing when UE is RRC connected. The Resume Request is sent to the CU-CP for processing and checking of the MAC-I. User data can be processed directly by the existing RLC Bearers and sent to CU-UP over existing tunnels. Data should be discarded on failure of MAC-I.

It is also important to highlight that PHY is based on default/common configuration compared with other ones that are part of the RLC bearer configuration which are based on stored configuration in UE and DU.

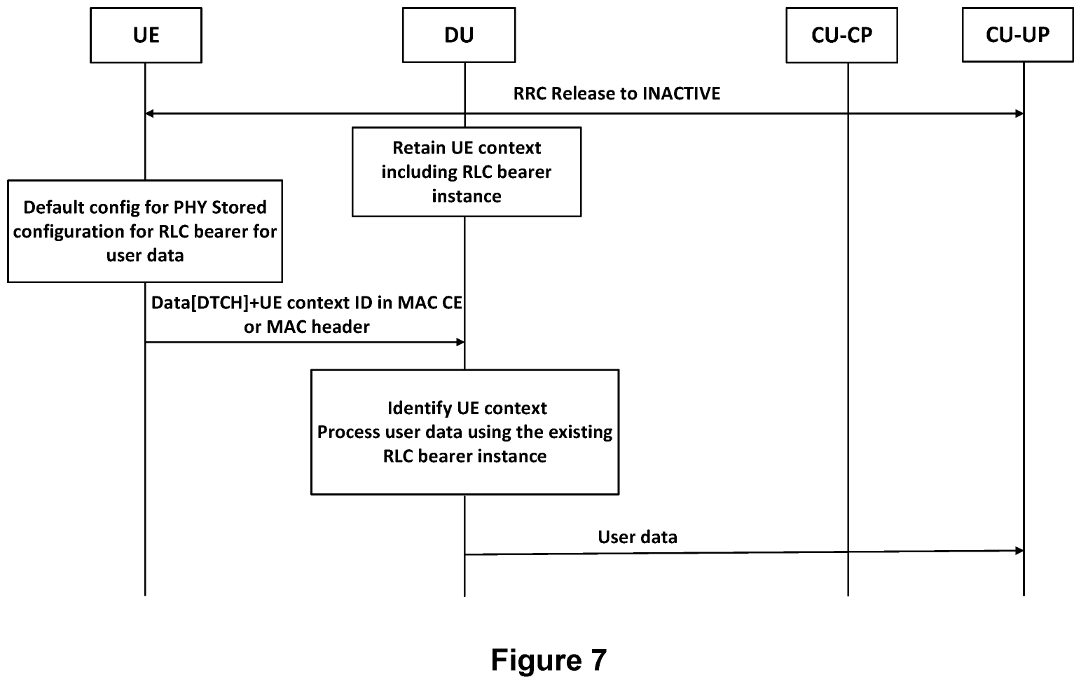

FIG. 7 gives an example handling for the option where the user context is retained in the DU with the difference that the 1^{st} UL message does not include a resume request but instead the data and optionally other UP related information (referred below as option 1.b)). On receipt of the user data along with information about the UE DU context ID, the DU identifies the UE context in the DU and the associated RLC bearer instances. The user data is processed by the appropriate RLC bearer identified by the MAC header of the data. The data can then be sent directly to the CU-UP for processing without any interaction with the CU-CP. Security verification can be based on integrity protection in the user plane data itself or additional MAC-I information included in MAC CE that could be processed in the DU itself or sent to CU-CP for verification.

RLC instance may be reset as part of this Resume (and/or suspend) procedure or the state information could be retained from the previous data transfer.

The RLC bearer created as above needs to be associated with the CU-UP configurations of PDCP and SDAP corresponding to the DRB and PDU session the data belong to. Since the UE is re-using previous configuration, it is also re-using the same LCID. The stored DU configuration is re-used for the RLC bearer. It is hence sufficient to re-use the previous LCID information in the data as the previous configuration will provide the association with the CU-UP context and the DRB/SDAP context. The CU-DU user plane tunnels information are also re-used. The CU-UP DRB instance and configuration are re-used of the DRB corresponding to the LCID. PDCP may be re-established, RoHC reset or continued from previous state. PDCP re-establishment can be done by default for every SDT transfer by hard capturing it in the specification or it could be signaled as part of the RRC release that provides the NCC.

Option 2) Temporarily Store the User Data at the DU (while UE is in INACTIVE) while Creating UE Context in the DU.

In this option 2, there is no user context stored in the DU when the DU receives the Resume+data from UE (as per previous option 1). This could be because the UE is resuming in another cell or because the DU is not storing user context when UE is INACTIVE.

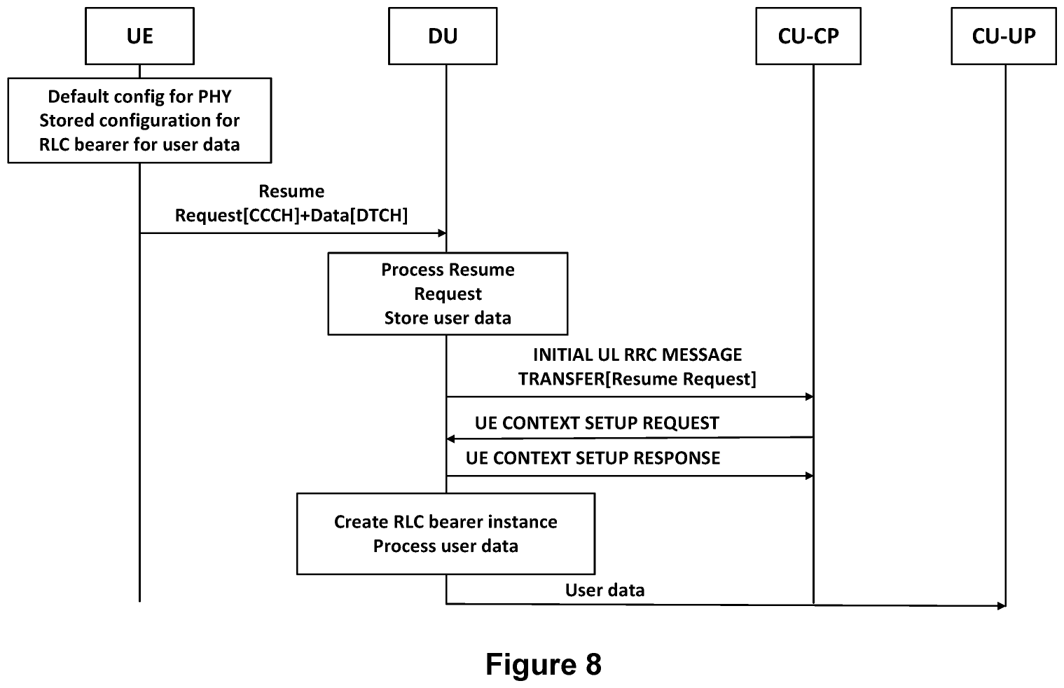

As with option 1, the UE sends ResumeRequest+user data to the network from INACTIVE. The Resume request is processed by the DU, and sent to the CU-CP. The user data component is stored in the DU without any RLC bearer processing. The CU-CP then provides the user configuration as part of the UE context to the DU that allows it to create the RLC bearers based on the UE configuration. Once the RLC bearers are established, the DU can process the stored user data through the RLC Bearers. This option 2 is characterized by (a) not keeping any UE context stored in DU (while in INACTIVE, as per legacy operation), (b) keeping UL data stored in DU until the RLC bearers are established, and (c) using the stored configurations (as per legacy operation). The message flow and expected operation of this option 2) is shown in FIG. 8.

The RLC bearer created as above needs to be associated with the CU-UP configurations of PDCP and SDAP corresponding to the DRB and PDU session the data belong to. This is similar to option 1 above. The tunnel(s) between the DU and CU-UP must be set up. This is done using normal procedure associated with setting up the UE context in the DU. Once it is set up, the data can be sent to the CU-UP. As with previous option, since the UE is re-using previous configuration, it is also re-using the same LCID. When the UE context is created in the DU, the association between the LCID and the DRB and the tunnel details for sending the data to the corresponding PDCP/SDAP for the DRB is also established in the DU.

The CU-UP DRB instance and configuration are re-used. PDCP may be re-established, RoHC reset or continued from previous state. PDCP re-establishment can be done by default for every SDT transfer by hard capturing it in the specification or it could be signalled as part of the RRC release that provides the NCC.

In another embodiment, information related to UE context id etc. may be sent via UP using for example MAC CE or header as an option 1b. This information is extracted and sent to the CU-CP and, the CU-CP provides the UE context to the DU as in option 1b. The rest of the processing is as above. Alternatively the information provided by UE to DU could be used to contact directly the CU-UP.

Irrespective of whether RRC message is used or not in msg 3/A in the UL SDT access, RRC messaging can be used in the DL by the network for providing the necessary information to the UE such as security configuration with an updated NCC. This could be done at the end of the SDT session or at any time during the SDT session.

In another embodiment, the transfer of security key related information such as NCC in the DL can be sent without explicitly using RRC signaling. It can be carried in MAC CE or header. The generation of corresponding security keys could later be handled as legacy operation (in RRC e.g. control plane), as well as, new operation as part of the user plane handling.

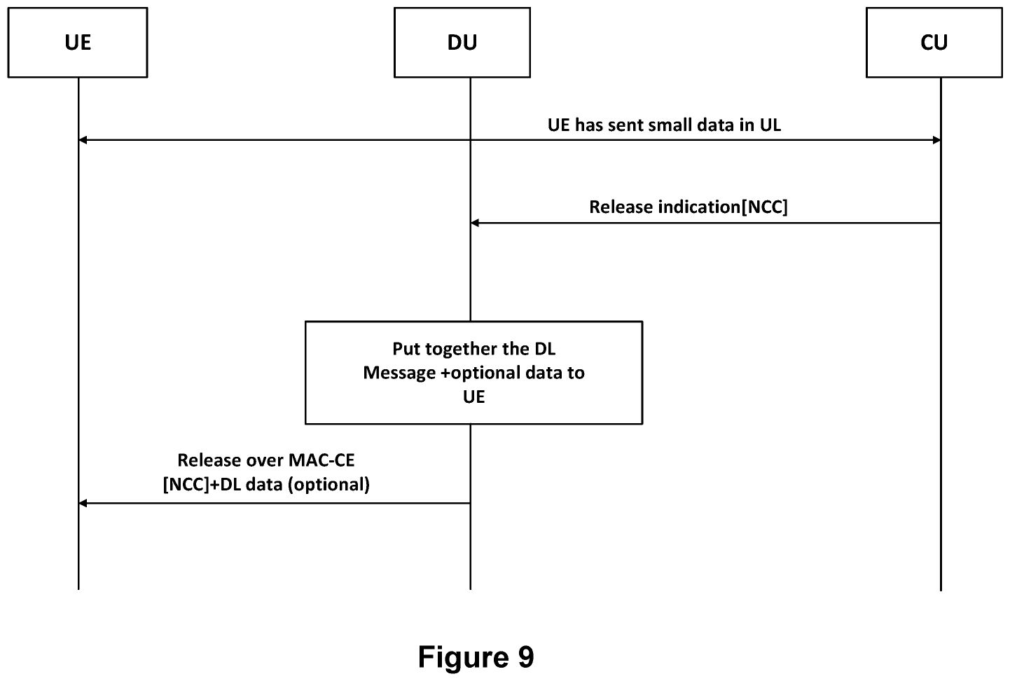

FIG. 9 shows how an updated NCC is provided in DL without RRC signaling.

### Option 3) Create an RLC Bearer Using Default Configuration on Receipt of the “Resume Request & Data”.

In this option, as with option 2, there is no UE context in the DU. UE sends ResumeRequest+user data or User data with UE context id etc. in MAC CE/header as in option 1 and 1b respectively.

The User data is sent using a default configuration for the RLC bearer. Since there is no UE specific configuration of the logical channel available at the UE, this RLC has to be based on a default configuration that is common for all users and preconfigured at the UE and known at the DU/CU. This common configuration for SDT can be defined in specification or provided by gNB via broadcast signaling or made known to the UE and DU in any other way. If the common configuration is determined by the CU, it can be configured in the DU using [enhanced] GNB-CU CONFIGURATION UPDATE F1-AP message.

On receipt of the user data, the DU can create the corresponding RLC bearer immediately without any input from the CU-CP as it uses the default configuration.

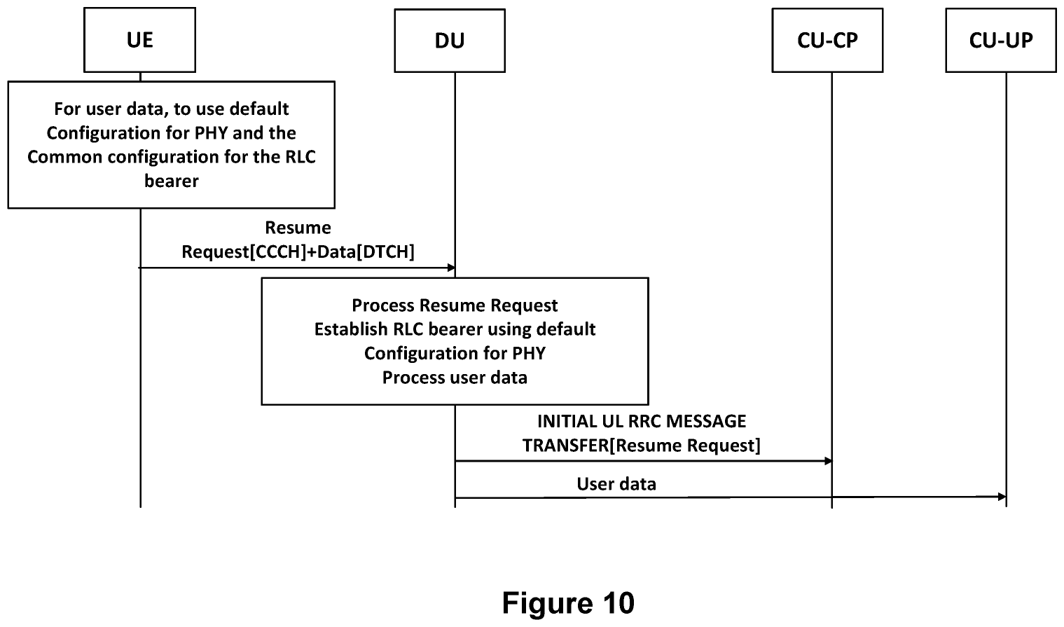

This option 3 is characterized by (a) not keeping any UE context stored in DU, (b) not exchanging UE CONTEXT SETUP REQUEST/RESPONSE message between the DU and CU, and (c) using default configurations already known to both UE and DU/CU. The message flow and expected operation of this option is shown in FIG. 10.

Note that DU would only process the data until the RLC layer but it would not de-crypt it (as this would be done in CU-UP) based on the PDU generated by the DU.

FIG. 10 does not show F1 and E1 signaling, which may still be needed to establish the UE context over these interfaces and to create user plane tunnels between DU and CU-CP. There are two options to overcome this problem:
1. Use F1 and E1 signaling to establish the context and the tunnels, as in legacy operation
2. Use a “default tunnel”, which is pre-established e.g. during the E1 interface establishment (which requires enhancements to E1 and F1 signaling). For example, F1 Setup and E1 Setup messages may be enhanced to carry the information about the default E1 tunnel.

As with the previous options, the RRC ResumeRequest or the MAC CE information is sent to the CU-CP for processing. Note that the initial UL RRC msg transfer could be sent earlier by DU to CU as soon as CU/DU does not continue to further process anything. A potential problem is if the CU could do any reconfiguration (which should be delayed until the 1st UL SDT data packet is fully completed).

The RLC bearer created as above needs to be associated with the CU-UP configurations of PDCP and SDAP corresponding to the DRB and PDU session the data belongs to. Since the UE is using a default configuration that is not reliant on the previous stored configuration, there is no immediate association in the DU between the created RLC bearer and UE DRB context in the CU-UP.

Some options to handle this association are provided below in accordance with various embodiments:
1) UE provides, along with the data, DRB ID and CU-UP ID corresponding to the data (this in addition to the LCID). The identity of the CU-UP may be part of the UE ID. A tunnel must be created between the DU and CU-UP and the DRB information provided to the CU-UP. The PDCP instance in the CU-UP for this DRB can be located and re-used. Alternatively, the CU-UP creates a new instance PDCP also based on default configuration. The association between the DRB and PDU session is stored in the CU-UP or retrieved from the CU-CP if there is no context in the CU-UP.
2) Instead of DRB ID above, UE provides the session ID for the data along with the data. The handling of the tunnels and data in the CU-UP is similar to the above based on the default PDCP configuration. Creating a new instance of PDCP in CU-UP based on default configuration and the session ID provides the information on where to send the data. As above, the ID of the CU-UP could be part of the UE ID. The UE security context must be available at the CU-UP to decrypt the packet. This could be stored in the CU-UP or retrieved from the CU-CP. Alternatively, a new CU-UP can be picked and a UE context with default PDCP and SDAP created and security context retrieved from the CU-CP.

As discussed above, the CU-UP DRB instance and configuration may be re-used. If so, PDCP may be re-established, RoHC reset or continued from previous state. PDCP re-establishment can be done by default for every SDT transfer by hard capturing it in the specification or it could be signalled as part of the RRC release that provides the NCC.

### Option 4) Create an RLC Bearer Using UE-Specific Configuration on Receipt of the “Data & UE-Specific Configuration”.

This is a variation of option 3. For performing SDT, if the UE prefers to use specific configuration instead of the default configuration (e.g. for MAC and RLC parameters) that were part of the UE context while the UE was previously in RRC_CONNECTED, it could provide this information along with 1^{st} UL SDT transmission (e.g. Msg. 3 for 4-step RACH, Msg.A for 2-step RACH or via the transmission on the PUR). That information (which indicates the UE-specific configuration to be used) can be provided as part of any of the following options (or their combination): a) the SDU header of the data (in RLC or MAC), b) MAC CE, or c) Resume request message IE. The DU could process the data and create RLC bearer applying such configuration for the data. Primarily, the necessary configuration represented as ‘SDT-Config’ for the UE specific configuration to aid in preparing the RLC bearer at the DU could include for example:

RLC Configuration
RLC configuration (AM or UM)
RLC SN field length (12 bits or 18 bits)
Old or chosen logical channel Identity
Old or chosen DRB Identity

MAC Logical Channel Configuration
priority
logical channel group identity (if any)

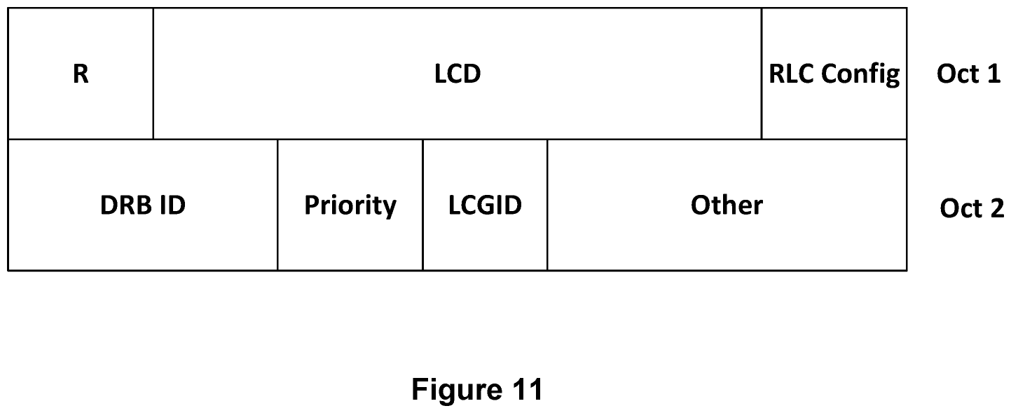

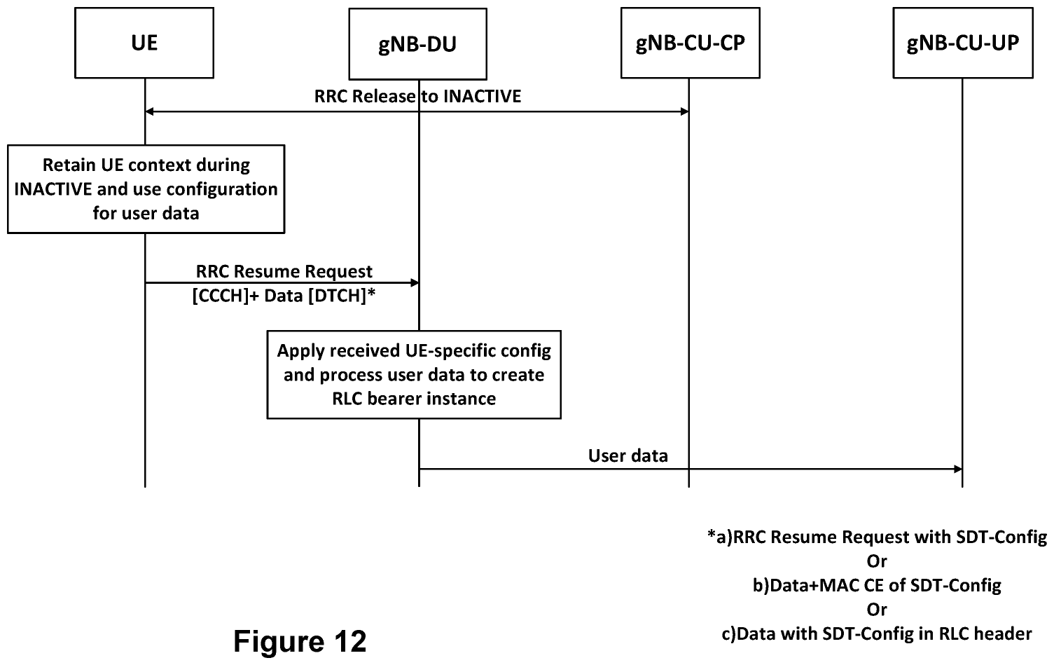

The message flow for this option is shown in FIG. 12. Since the UE context is not yet retrieved and available at the DU, the UE may provide some basic configuration information of the most important IEs within RRC Resume request message (part of SDT-Config defined above) which the DU can process and obtain the necessary configuration. Or another way is for the UE to provide this config in the header e.g. using any of the reserved bits or extending it with additional octet. Another way is to define a new MAC CE specifically to carry SDT configuration (such as shown below in FIG. 11) or to carry an indicator that network can also map to a set of parameters for the pre-configured or pre-defined configuration. This can be kept to minimal required information sent along with the first UL message. FIG. 12 does not show any signaling between DU and CU-CP, however it may be also defined that DU updates the CU-CP with the Resume Request message and configurations in used, as well, as other potential ones such as to provide the Release message.

Similar to option 3, F1 and E1 signaling, which is not shown in FIG. 11, may still be needed. As in option 3, either F1 and E1 legacy signaling can be used or a default E1 tunnel can be pre-configured for that purpose.

This option 4 is characterized by (a) keeping UE context stored in UE while in inactive, (b) processing data at DU without having to exchange the UE CONTEXT SETUP REQUEST/RESPONSE message between the DU and CU, and (c) using UE-specific configurations provided by the UE to the DU and, when needed, the same configuration is passed to the CU by the DU.

Alternatively, the configuration provided by UE to DU with option 4 could be understood as a UE's preference (similar to UE assistance mechanism) for the network to take into consideration. Therefore, the network could determine whether it accepts those preference or not e.g. by providing the updated configuration to be used.

Table 1 below summarizes the key differences between legacy operation and each of the new options described herein:

TABLE 1
Summary of the disclosed options to handle data
exchange with the new SDT mechanism at the DU

| Characteristics | Option 1) | Option 2) | Option 3) | Option 4) |
|---|---|---|---|---|
| Actions upon UE | DU retains | Legacy NR suspend | Legacy NR | Legacy NR |
| transitions into | the user | operation | suspend | suspend |
| RRC_INACTIVE | context and | | operation (e.g. | operation |
| | RLC bearers | | UE context and | |
| | while UE is | | RLC bearers are | |
| | in | | released from | |
| | INACTIVE | | DU). | |
| Actions upon UE | UE and DU | Legacy NR resume | RLC bearers are | UE provides to |
| starts UL SDT | uses the | operation (e.g. DU | established in | the DU the UE- |
| while in | previously | sends resume request to | UE and then in | specific |
| RRC_INACTIVE | stored UE | CU that triggers the | the DU on | configuration in |
| | context and | setup of the UE context | receipt of the | used to |
| | RLC bearer | and its associated RLC | user data based | exchange SDT. |
| | configuration | bearer in the DU). | on a default or | |
| | | However, there is a new | common | |
| | | initial step: DU needs | configuration | |
| | | to store the 1^{st} UL data | | |
| | | sent until RLC bearer is | | |
| | | established. | | |
| Actions upon UE | DU retains | Legacy NR suspend | Legacy NR | Legacy NR |
| ends all UL/DL | the UE | operation | suspend | suspend |
| SDT while in | context and | | operation (e.g. | operation |
| RRC_INACTIVE | the RLC | | UE context and | |
| | bearer | | RLC bearers are | |
| | instance | | released from | |
| | | | DU). | |
| Configurations in | Stored | Based on legacy NR | Default or | UE-specific |
| use for SDT | configuration | resume procedure (e.g. | common | configuration |
| (while in | | stored configuration is | configuration | (based on |
| RRC_INACTIVE) | | used until updated by | are in use | default, common |
| | | the network). | | or stored within |
| | | | | the UE Context) |
| Signaling | Option 1) | Based on legacy NR | INITITIAL UL | Only when/if |
| between DU/CU | DU still | resume procedure | RRC | needed (e.g. to |
| when sending | informs CU | (INITITIAL UL RRC | MESSAGE | provide the UE- |
| “Resume Request + | (similar to | MESSAGE, and UE | (Note: It is not | specific |
| Data” | option 3) | CONTEXT SETUP | exchanged UE | configuration in |
| | Option 1.b) | REQUEST/RESPONSE) | CONTEXT | used)' |
| | DU does not | | SETUP | |
| | need to | | REQUEST or | |
| | inform CU | | RESPONSE | |
| | | | messages) | |
| RLC bearer | RLC bearers | Similar to legacy | DU creates RLC | Created at |
| instance at | are retained | operation, DU retrieves | bearer using | the DU using |
| the DU | at the DU | UE context from CU | commonly known | UE-specific |
| | while UE is | and resumes the RLC | configuration | configuration |
| | in INACTIVE | bearer upon start of | and uses default | provided along |
| | (when performing | SDT (and releases/ | configuration | with 1^{st} UL SDT |
| | SDT or not) | suspends it | for PHY upon | (and releases/ |
| | | upon end of SDT) | start of SDT | suspends them |
| | | | (and releases/ | upon end of |
| | | | suspends them | SDT) |
| | | | upon end of | |
| | | | SDT) | |

For any of the above options, when multiple data transmissions are exchanged using any of the above options, after the first data transmissions or at any point of time while exchanging the SDT, the network could inform the UE (implicitly or explicitly) when default PHY does not need to be used and UE can use other configuration e.g. the stored PHY config or any updated one. This information could be conveyed by different means, such as, via L1 indication, RRC signaling (e.g. RRC resume which may trigger a fallback to RRC_CONNECTED, or RRC Reconfiguration).

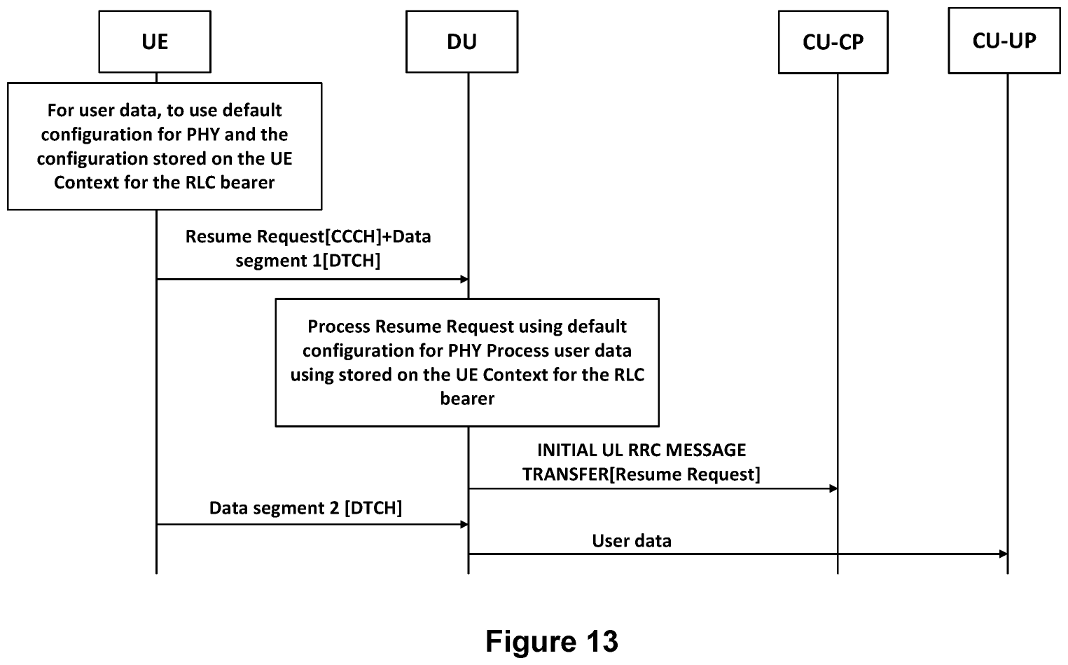

For example, assuming option 1, if the data is to be segmented, the UE sends the remaining segments using the same configuration as for msg3/msg A. The DU will process all the segments together on the RLC bearer created using the same configuration and same RLC instance. When the data SDU is received completely, it is sent to the CU-UP as shown in FIG. 13. The initial UL RRC message transfer may occur before or after receiving all the data segments from the UE.

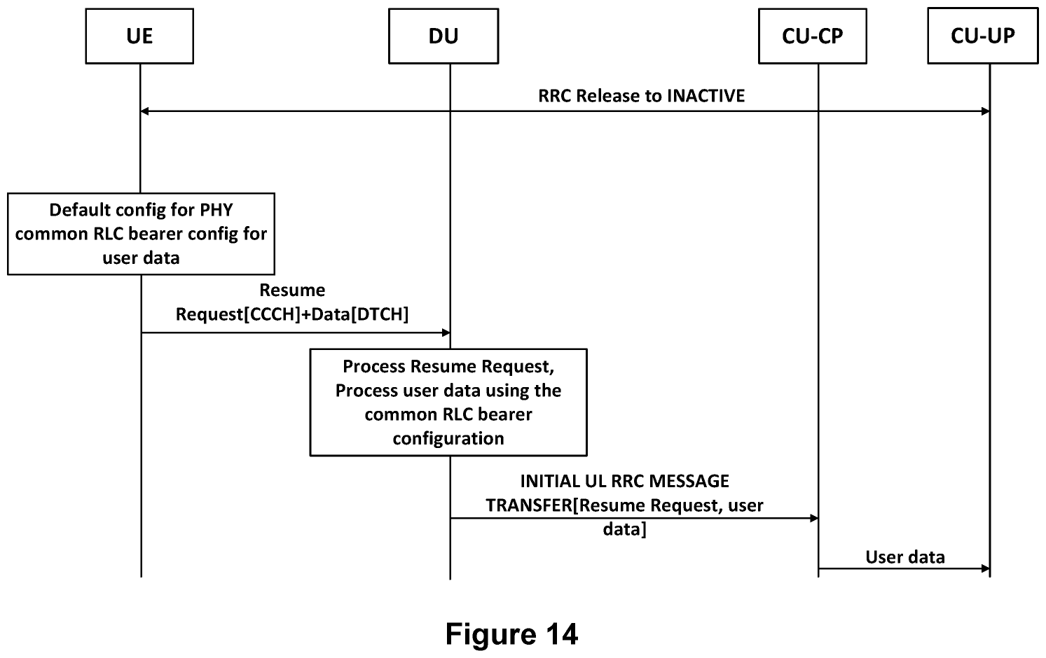

In another embodiment, the user data may also be sent to the CU-CP by the DU along with the Resume Request in the INITIAL RRC message transfer. The CU-CP then subsequently forwards it to the CU-UP. This operation is applicable to any of the new solution options described in this disclosure and it is as shown in FIG. 14 as an example based on option 3 (using common configuration). This solution assumes that the tunnel between the DU and the CU-UP is not there or maintained; therefore, instead of establishing it, the data is sent by DU via the CU-CP.

If the UL data were segmented, and multiple subsequent transmissions were done, the DU may handle the re-assembly of the data before forwarding it to the CU.

Any of the above options and embodiments can also be used with preconfigured UL resources (PUR). Instead of sending Resume Request and/or user data in msg A or msg 3, it can be sent on the PUR. The handling in the UE and RAN nodes will be similar to the above for the different options.

The forwarding of data through the CU-CP allows the delay and additional messaging of sending the UE context to the DU and establishment of the tunnel between the DU and CU-UP. For the DL, it also makes it easier to coordinate the DL packet and RRC messages with the CU-CP sending them together to the DU such that the DU can send them together to the UE.

### 1.4 Handling Downlink Data and Release/Suspension for a UE in INACTIVE Exchanging Data

In prior techniques, any DL data is multiplexed with RRC release message and sent together to the UE. For an integrated gNB, the two can be combined easily. However with a separate CU-CP and CU-UP, the RRC release message comes from the CU-CP while the user data comes from the CU-UP. The two are asynchronous and hence the Release message and data may arrive at the DU at different times, and in any order. The DU needs to wait and collect the two and put them together to send to the UE.

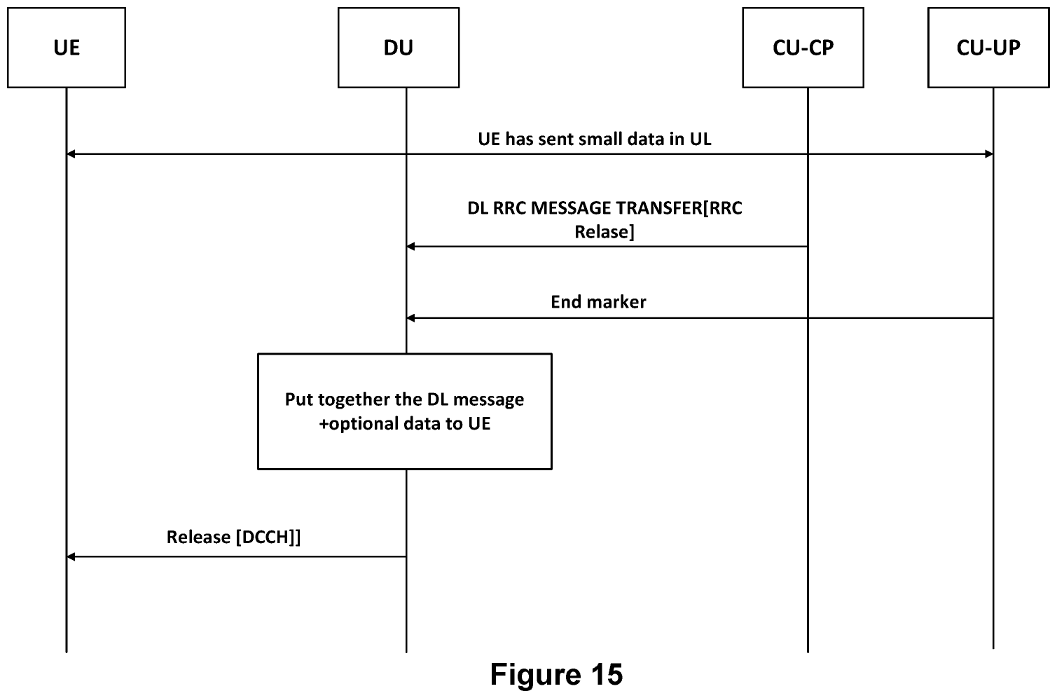

Additional challenges come from having to handle other possibilities. For example, there may not be any DL data to send. In that case, the CU-UP may send an indication to the DU such as End marker that it has no data to send to the UE or the DL data being sent is the last packet expected. This is shown in FIG. 15.

This end marker mechanism may also be used if there are multiple packets to be sent in the DL and CU-UP can indicate that there are no further packets.

The end marker may also be an indication to the CP and CP then sends the RRC release to the DU. For this, E1-AP enhancements may be needed. For example, E1-AP DL DATA

NOTIFICATION message can be enhanced to carry the end marker from CU-UP to CU-CP. In this way, the CU-UP may also inform the CU-CP when the last data packet is sent and no more data is expected. If so, this information may be used by CU-CP to trigger the RRCRelease. Another approach is that the CU-UP could also send to the CU-CP both the data and the indication (e.g. that no more data is foreseen and that this is the last packet), in which case, the CU-CP can send this data together with the RRC Release message to the DU.

When all of the UL/DL SDT exchange is completed, DU might need to release or suspend, depending on the selected options, the established RLC bearers and UE context associated with the configuration in used. Possible ways to enable this include:
a) Network indicates to release or suspend them from the UE and the DU/CU. This option a) could re-use legacy trigger where CU sends DL RRC MESSAGE TRANSFER message to DU, which would send the release message to the UE. If the suspension were applicable, it may be optional whether the DU informs or not the CU.
b) UE and CU/DU autonomously release or suspend them. This could be triggered via a timer or via a new event (e.g. upon exchanging a DL ACK or data that indicates that it is the last SDT).
   1.5 New Mechanism for a UE in INACTIVE Exchanging Data when UE AS Context is Available in a Given CU Region

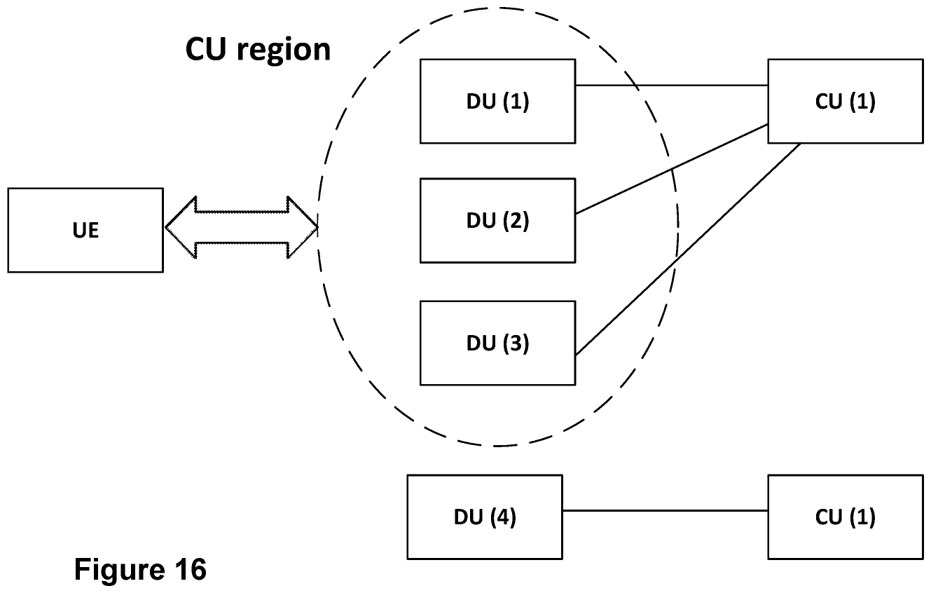

This section focuses on the scenario when a UE in RRC_INACTIVE aims to exchange data in a given DU within the CU region where the UE AS Context was stored. For this SDT operation where the UE AS context is available in the new gNB implies that it is the same as gNB where the UE AS Context was stored (referred in this discussion for simplicity as “anchor gNB”). Moreover, with the CU/DU split architecture, the UE AS Context could be available within a given CU region (or can be referred to as inter-DU or intra-CU mobility scenario) where one CU serves one or more DUs (referred in this discussion for simplicity as “anchor CU region”).
Rel-15 NR: DU may check RRCResumeRequest information in legacy NR INACTIVE operation (e.g. for the cause value or other information). The main premise being that the reject behavior described in 38.413 which implies that the DU has decoded and looked at the message and cause value and decided whether or not it can serve the UE.
The concept that DUs served by a given CU might be defined, such as, by a “CU region” or “CU region boundary”, as shown in example of FIG. 16.
UE may recognize its current anchor CU region or when crossing in an implicit or explicit way. The CU boundary of a given CU region may be defined by:
   (a) a new ID to differentiate a given CU region
   (b) re-using the cell ID or RNA ID (fully or partially)
The UE may be configured by the network with its corresponding “CU region” or “CU boundary” explicitly via dedicated and/or broadcast signaling, or implicitly via some definition added in specification.
When UE is aware that it is within that anchor CU region, SDT mechanism could be enhanced to follow a non-RRC signaling based approach.
   The MAC header could differentiate transmission of small data (e.g. SDT) vs signaling (e.g. SST). This way, the SDT could be handled by the DU and the SST by DU or by CU.
   Moreover, new signaling may be defined between CU/DU for both SDT/SST. This may impact UP protocol stack handling.
   This SDT could access via pre-configured resources or sending it directly in Msg.3 after getting an UL allocation.
If a UE has an ongoing SDT while crossing its CU boundary, different handlings could be possible:
   (a) SDT is considered a failure
   (b) SDT may continue. If so, some form of DL RRC message would provide at least the new NCC. In addition, data forwarding may need to be handled. Alternatively, UE may rely on a mechanism similar to re-establishment.
The main benefit of defining the CU region is when the configuration is used based on the default or common or pre-defined or pre-configured as discussed in other sections.
   1.6 New Mechanism for a UE in INACTIVE Exchanging Data when UE AS Context is not Available in a Given CU Region—Handling without Context Relocation
   1.6.1 General SDT Operation without UE AS Context Relocation

When the UE sends data in another gNB where the UE AS Context is not stored (e.g. different CU region), and the gNB would need to retrieve the UE AS context, as per legacy operation or a new mechanism can be defined that allows the exchange of DL/UL data while in RRC_INACTIVE without UE AS Context relocation.

The SDT operation without UE AS context implies that the new gNB where UE accesses will not get transferred the UE AS Context that resides in the old/previous gNB (referred for this discussion for simplicity as “anchor gNB”). Two approaches are possible:
Approach 1) New gNB forwards the UE PDUs to the anchor gNB to decode the information
   Advantages:
      UE AS context is only kept in one place (e.g. anchor gNB)
      The security keys generated by one gNB (e.g. anchor gNB) are not shared across the different network nodes.
      This approach is similar to Rel-15 RNAU procedure where the anchor gNB responds to the new gNB via a “RETRIEVE UE CONTEXT FAILURE” including an encapsulated RRCRelease message for the new gNB (that will later send it transparently to the UE).
         TS 38.423 specifies that this RRCRelease message is encapsulated in a PDCP-C PDU
   Disadvantages:
      New gNB needs to keep UE's temporary context even while UE is still not authenticated (as this is done by the anchor gNB and would add some delay before knowing whether authentication is or not successful).
      UL Data is sent to the anchor gNB at the same time or before authenticating the UE (as the authentication is done by the anchor gNB). Therefore, if UE fails authentication, UL data was sent unnecessarily to the anchor gNB. Alternatively new gNB can firstly send the RRCResumeRequest message to the anchor gNB and wait for ACK before sharing that 1st UL SDT. However this would add delay and complexity to SDT operation that aims to reduce the time require to exchange SDT and to keep UE active.
Approach 2) New gNB gets a copy of the UE context or security keys required from “anchor gNB”
   Advantages:
      New gNB can authenticate directly the UE.
      New gNB gets a temporary copy of the UE context from the anchor gNB that gets deleted after SDT is done.
   Disadvantages:
      Sharing security information across 2 gNBs
      Keeping redundant information across 2 gNBs
      Trust that the new gNB to delete the UE AS context and security keys upon using them.
      The anchor gNB would need to send to the new gNB the stored UE AS Context, as well as, the updated information to be provided to the UE when suspending the connection again (e.g. if needed, a new I-RNTI, new NCC, new RNA).
      The new gNB would need to encode the RRCRelease using the security context of the anchor gNB.
      DL data received by the anchor gNB would need to be forwarded to the new gNB.
      UL data is forwarded to the anchor gNB (as the bearers are kept from there).

On summary, approach 1) may be preferable over approach 2) to enable SDT operation without UE AS context. Further details added below on how to exchange UL/DL data btwn new gNB and anchor gNB (as it would be a new mechanism as in Rel-15 NR this only handles control plane messages e.g. RRCResumeRequest and RRCRelease).

1.6.2 Data Handling for SDT Operation without UE AS Context Relocation

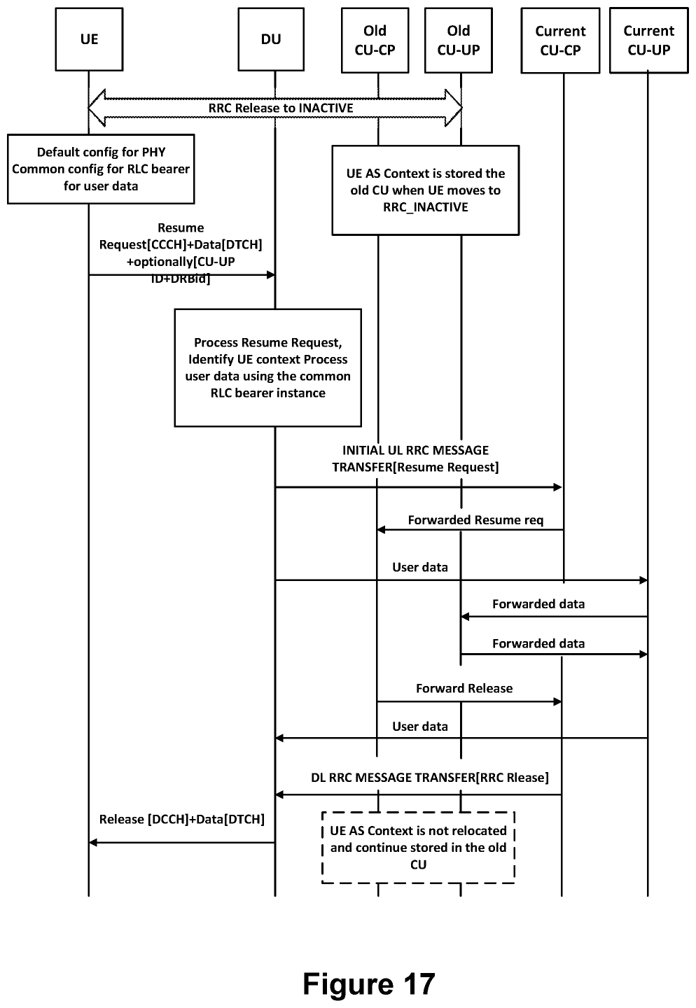

Assumption is that UL data is forwarded by the new gNB to the anchor gNB in order to decrypt it, and DL data is forwarded by the anchor gNB to the new gNB. This data may be forwarded as a MAC SDU. The following text and FIG. 17 describe how the data is handled when having DU/CU split scenarios, however similar mechanism is also applicable when CU/DU are collocated (which would require less signaling) as new gNB could communicate directly with the old (or anchor) gNB.

When the UE sends data in another CU region, and the current DU cannot directly reach the CU-CP/CU-UP where the UE context is previously stored, some additional mechanism is needed to process the data (assuming that the UE AS context is not relocated from the old CU). FIG. 17 shows the scenario where the common configuration is used for the RLC bearer. The UE also provides the DRBid and CU-CP/CU-UP IDs. These IDs could be provided directly or could be inferred from the Resume ID or logical channel ID using some known mapping of the UE and DU. The DU can process the Resume Request and the data using the common configuration and sends it respectively to the CU-CP and CU-UP connected to the DU. These new CU-CP/CU-UP would also forward the corresponding signaling/data to the old CU-CP/CU-UP where the UE was previously connected, as well as, other required information for example, to identify the UE id and DRB id for the data. A tunnel can be established between the DU and the current CU-UP and also between the current CU-UP and the old CU-UP for transport of the data. The tunnel establishment between the DU and current CU-UP can be established based on signaling from the current CU-CP sent along with the forwarded signaling from the old CU-CP or it could be sent separately. The previous CU-CP/CU-UP will further process the data using the UE context (for example, security context to verify and decrypt the data) and send to the UPF. The reverse operation happens for the DL with data/signaling forwarded from the previous CU-CP/CU-UP to the DU through the current CU-CP/CU-UP as shown in FIG. 17. In addition, the data part may need to have the UE related ID as well as a tunneling related ID (such as, the DRB ID) allocated by the DU (or alternatively by UE).

Considering option 2 where the stored RLC bearer configuration is used, the configuration must be made available to the DU from the previous CU-CP/CU-UP before the DU can process the data. This could be done through the current CU-CP/CU-UP. Otherwise the rest of the processing remains the same as above.

It is also possible to retain the UE context in the DU for option 1 even when the DU is not directly connected to the previous CU-CP/CU-UP. The current CU-CP/CU-UP can provide a forwarding path as discussed above.

Any combination of the above can also be used. If the UE uses different configuration for the different scenarios, the configuration to use can be indicated by network for example by broadcast. This indication could be implicit for example by means of some ID indicating that the same configuration can be used in a region of cells or explicit.

### Systems and Implementations

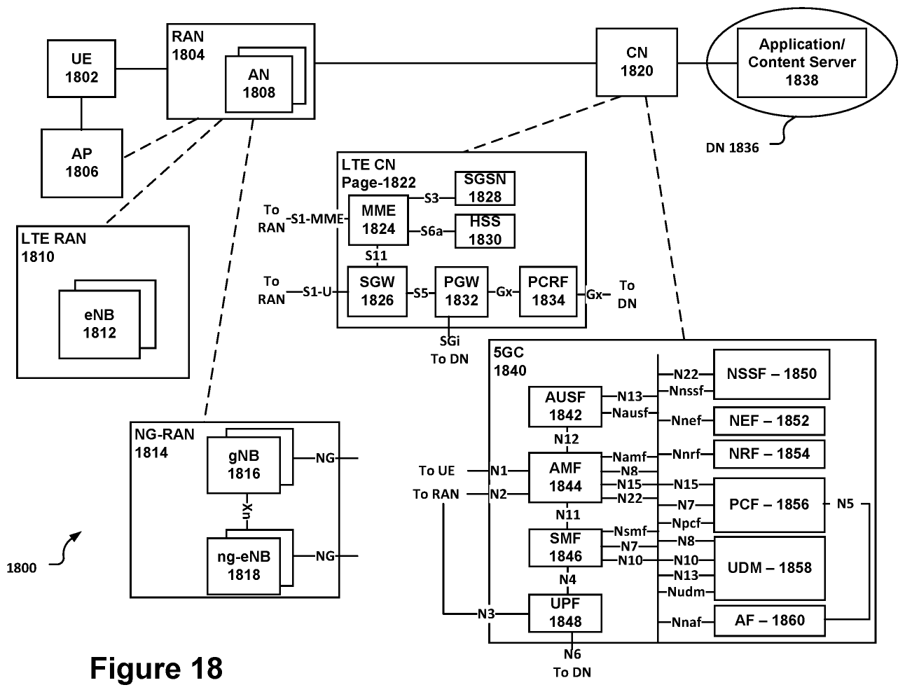

FIGS. 18-20 illustrate various systems, devices, and components that may implement aspects of disclosed embodiments.

FIG. 18 illustrates a network 1800 in accordance with various embodiments. The network 1800 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1800 may include a UE 1802, which may include any mobile or non-mobile computing device designed to communicate with a RAN 1804 via an over-the-air connection. The UE 1802 may be communicatively coupled with the RAN 1804 by a Uu interface. The UE 1802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1802 may additionally communicate with an AP 1806 via an over-the-air connection. The AP 1806 may manage a WLAN connection, which may serve to offload some/all network traffic from the RAN 1804. The connection between the UE 1802 and the AP 1806 may be consistent with any IEEE 802.11 protocol, wherein the AP 1806 could be a wireless fidelity (Wi-Fi®) router. In some embodiments, the UE 1802, RAN 1804, and AP 1806 may utilize cellular-WLAN aggregation (for example, LWA/LWIP). Cellular-WLAN aggregation may involve the UE 1802 being configured by the RAN 1804 to utilize both cellular radio resources and WLAN resources.

The RAN 1804 may include one or more access nodes, for example, AN 1808. AN 1808 may terminate air-interface protocols for the UE 1802 by providing access stratum protocols including RRC, PDCP, RLC, MAC, and L1 protocols. In this manner, the AN 1808 may enable data/voice connectivity between CN 1820 and the UE 1802. In some embodiments, the AN 1808 may be implemented in a discrete device or as one or more software entities running on server computers as part of, for example, a virtual network, which may be referred to as a CRAN or virtual baseband unit pool. The AN 1808 be referred to as a BS, gNB, RAN node, eNB, ng-eNB, NodeB, RSU, TRxP, TRP, etc. The AN 1808 may be a macrocell base station or a low power base station for providing femtocells, picocells or other like cells having smaller coverage areas, smaller user capacity, or higher bandwidth compared to macrocells.

In embodiments in which the RAN 1804 includes a plurality of ANs, they may be coupled with one another via an X2 interface (if the RAN 1804 is an LTE RAN) or an Xn interface (if the RAN 1804 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1804 may each manage one or more cells, cell groups, component carriers, etc. to provide the UE 1802 with an air interface for network access. The UE 1802 may be simultaneously connected with a plurality of cells provided by the same or different ANs of the RAN 1804. For example, the UE 1802 and RAN 1804 may use carrier aggregation to allow the UE 1802 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1802 or AN 1808 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1804 may be an LTE RAN 1810 with eNBs, for example, eNB 1812. The LTE RAN 1810 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1804 may be an NG-RAN 1814 with gNBs, for example, gNB 1816, or ng-eNBs, for example, ng-eNB 1818. The gNB 1816 may connect with 5G-enabled UEs using a 5G NR interface. The gNB 1816 may connect with a 5G core through an NG interface, which may include an N2 interface or an N3 interface. The ng-eNB 1818 may also connect with the 5G core through an NG interface, but may connect with a UE via an LTE air interface. The gNB 1816 and the ng-eNB 1818 may connect with each other over an Xn interface.

In some embodiments, the NG interface may be split into two parts, an NG user plane (NG-U) interface, which carries traffic data between the nodes of the NG-RAN 1814 and a UPF 1848 (e.g., N3 interface), and an NG control plane (NG-C) interface, which is a signaling interface between the nodes of the NG-RAN 1814 and an AMF 1844 (e.g., N2 interface).

The NG-RAN 1814 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1802 can be configured with multiple BWPs where each BWP configuration has a different SCS. When a BWP change is indicated to the UE 1802, the SCS of the transmission is changed as well. Another use case example of BWP is related to power saving. In particular, multiple BWPs can be configured for the UE 1802 with different amount of frequency resources (for example, PRBs) to support data transmission under different traffic loading scenarios. A BWP containing a smaller number of PRBs can be used for data transmission with small traffic load while allowing power saving at the UE 1802 and in some cases at the gNB 1816. A BWP containing a larger number of PRBs can be used for scenarios with higher traffic load.

The RAN 1804 is communicatively coupled to CN 1820 that includes network elements to provide various functions to support data and telecommunications services to customers/subscribers (for example, users of UE 1802). The components of the CN 1820 may be implemented in one physical node or separate physical nodes. In some embodiments, NFV may be utilized to virtualize any or all of the functions provided by the network elements of the CN 1820 onto physical compute/storage resources in servers, switches, etc. A logical instantiation of the CN 1820 may be referred to as a network slice, and a logical instantiation of a portion of the CN 1820 may be referred to as a network sub-slice.

In some embodiments, the CN 1820 may be an LTE CN 1822, which may also be referred to as an EPC. The LTE CN 1822 may include MME 1824, SGW 1826, SGSN 1828, HSS 1830, PGW 1832, and PCRF 1834 coupled with one another over interfaces (or “reference points”) as shown. Functions of the elements of the LTE CN 1822 may be briefly introduced as follows.

The MME 1824 may implement mobility management functions to track a current location of the UE 1802 to facilitate paging, bearer activation/deactivation, handovers, gateway selection, authentication, etc.

The SGW 1826 may terminate an S1 interface toward the RAN and route data packets between the RAN and the LTE CN 1822. The SGW 1826 may be a local mobility anchor point for inter-RAN node handovers and also may provide an anchor for inter-3GPP mobility. Other responsibilities may include lawful intercept, charging, and some policy enforcement.

The SGSN 1828 may track a location of the UE 1802 and perform security functions and access control. In addition, the SGSN 1828 may perform inter-EPC node signaling for mobility between different RAT networks; PDN and S-GW selection as specified by MME 1824; MME selection for handovers; etc. The S3 reference point between the MME 1824 and the SGSN 1828 may enable user and bearer information exchange for inter-3GPP access network mobility in idle/active states.

The HSS 1830 may include a database for network users, including subscription-related information to support the network entities' handling of communication sessions. The HSS 1830 can provide support for routing/roaming, authentication, authorization, naming/addressing resolution, location dependencies, etc. An S6a reference point between the HSS 1830 and the MME 1824 may enable transfer of subscription and authentication data for authenticating/authorizing user access to the LTE CN 1820.

The PGW 1832 may terminate an SGi interface toward a data network (DN) 1836 that may include an application/content server 1838. The PGW 1832 may route data packets between the LTE CN 1822 and the data network 1836. The PGW 1832 may be coupled with the SGW 1826 by an S5 reference point to facilitate user plane tunneling and tunnel management. The PGW 1832 may further include a node for policy enforcement and charging data collection (for example, PCEF). Additionally, the SGi reference point between the PGW 1832 and the data network 18 36 may be an operator external public, a private PDN, or an intra-operator packet data network, for example, for provision of IMS services. The PGW 1832 may be coupled with a PCRF 1834 via a Gx reference point.

The PCRF 1834 is the policy and charging control element of the LTE CN 1822. The PCRF 1834 may be communicatively coupled to the app/content server 1838 to determine appropriate QoS and charging parameters for service flows. The PCRF 1832 may provision associated rules into a PCEF (via Gx reference point) with appropriate TFT and QCI.

In some embodiments, the CN 1820 may be a 5GC 1840. The 5GC 1840 may include an AUSF 1842, AMF 1844, SMF 1846, UPF 1848, NSSF 1850, NEF 1852, NRF 1854, PCF 1856, UDM 1858, and AF 1860 coupled with one another over interfaces (or “reference points”) as shown. Functions of the elements of the 5GC 1840 may be briefly introduced as follows.

The AUSF 1842 may store data for authentication of UE 1802 and handle authentication-related functionality. The AUSF 1842 may facilitate a common authentication framework for various access types. In addition to communicating with other elements of the 5GC 1840 over reference points as shown, the AUSF 1842 may exhibit an Nausf service-based interface.

The AMF 1844 may allow other functions of the 5GC 1840 to communicate with the UE 1802 and the RAN 1804 and to subscribe to notifications about mobility events with respect to the UE 1802. The AMF 1844 may be responsible for registration management (for example, for registering UE 1802), connection management, reachability management, mobility management, lawful interception of AMF-related events, and access authentication and authorization. The AMF 1844 may provide transport for SM messages between the UE 1802 and the SMF 1846, and act as a transparent proxy for routing SM messages. AMF 1844 may also provide transport for SMS messages between UE 1802 and an SMSF. AMF 1844 may interact with the AUSF 1842 and the UE 1802 to perform various security anchor and context management functions.

Furthermore, AMF 1844 may be a termination point of a RAN CP interface, which may include or be an N2 reference point between the RAN 1804 and the AMF 1844; and the AMF 1844 may be a termination point of NAS (N1) signaling, and perform NAS ciphering and integrity protection. AMF 1844 may also support NAS signaling with the UE 1802 over an N3 IWF interface.

The SMF 1846 may be responsible for SM (for example, session establishment, tunnel management between UPF 1848 and AN 1808); UE IP address allocation and management (including optional authorization); selection and control of UP function; configuring traffic steering at UPF 1848 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1844 over N2 to AN 1808; and determining SSC mode of a session. SM may refer to management of a PDU session, and a PDU session or “session” may refer to a PDU connectivity service that provides or enables the exchange of PDUs between the UE 1802 and the data network 1836.

The UPF 1848 may act as an anchor point for intra-RAT and inter-RAT mobility, an external PDU session point of interconnect to data network 1836, and a branching point to support multi-homed PDU session. The UPF 1848 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1848 may include an uplink classifier to support routing traffic flows to a data network.

The NSSF 1850 may select a set of network slice instances serving the UE 1802. The NSSF 1850 may also determine allowed NSSAI and the mapping to the subscribed S-NSSAIs, if needed. The NSSF 1850 may also determine the AMF set to be used to serve the UE 1802, or a list of candidate AMFs based on a suitable configuration and possibly by querying the NRF 1854. The selection of a set of network slice instances for the UE 1802 may be triggered by the AMF 1844 with which the UE 1802 is registered by interacting with the NSSF 1850, which may lead to a change of AMF. The NSSF 1850 may interact with the AMF 1844 via an N22 reference point; and may communicate with another NSSF in a visited network via an N31 reference point (not shown). Additionally, the NSSF 1850 may exhibit an Nnssf service-based interface.

The NEF 1852 may securely expose services and capabilities provided by 3GPP network functions for third party, internal exposure/re-exposure, AFs (e.g., AF 1860), edge computing or fog computing systems, etc. In such embodiments, the NEF 1852 may authenticate, authorize, or throttle the AFs. NEF 1852 may also translate information exchanged with the AF 1860 and information exchanged with internal network functions. For example, the NEF 1852 may translate between an AF-Service-Identifier and an internal 5GC information. NEF 1852 may also receive information from other NFs based on exposed capabilities of other NFs. This information may be stored at the NEF 1852 as structured data, or at a data storage NF using standardized interfaces. The stored information can then be re-exposed by the NEF 1852 to other NFs and AFs, or used for other purposes such as analytics. Additionally, the NEF 1852 may exhibit an Nnef service-based interface.

The NRF 1854 may support service discovery functions, receive NF discovery requests from NF instances, and provide the information of the discovered NF instances to the NF instances. NRF 1854 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1854 may exhibit the Nnrf service-based interface.

The PCF 1856 may provide policy rules to control plane functions to enforce them, and may also support unified policy framework to govern network behavior. The PCF 1856 may also implement a front end to access subscription information relevant for policy decisions in a UDR of the UDM 1858. In addition to communicating with functions over reference points as shown, the PCF 1856 exhibit an Npcf service-based interface.

The UDM 1858 may handle subscription-related information to support the network entities' handling of communication sessions, and may store subscription data of UE 1802. For example, subscription data may be communicated via an N8 reference point between the UDM 1858 and the AMF 1844. The UDM 1858 may include two parts, an application front end and a UDR. The UDR may store subscription data and policy data for the UDM 1858 and the PCF 1856, and/or structured data for exposure and application data (including PFDs for application detection, application request information for multiple UEs 1802) for the NEF 1852. The Nudr service-based interface may be exhibited by the UDR 221 to allow the UDM 1858, PCF 1856, and NEF 1852 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1858 may exhibit the Nudm service-based interface.

The AF 1860 may provide application influence on traffic routing, provide access to NEF, and interact with the policy framework for policy control.

In some embodiments, the 5GC 1840 may enable edge computing by selecting operator/3^{rd} party services to be geographically close to a point that the UE 1802 is attached to the network. This may reduce latency and load on the network. To provide edge-computing implementations, the 5GC 1840 may select a UPF 1848 close to the UE 1802 and execute traffic steering from the UPF 1848 to data network 1836 via the N6 interface. This may be based on the UE subscription data, UE location, and information provided by the AF 1860. In this way, the AF 1860 may influence UPF (re)selection and traffic routing. Based on operator deployment, when AF 1860 is considered to be a trusted entity, the network operator may permit AF 1860 to interact directly with relevant NFs. Additionally, the AF 1860 may exhibit an Naf service-based interface.

The data network 1836 may represent various network operator services, Internet access, or third party services that may be provided by one or more servers including, for example, application/content server 1838.

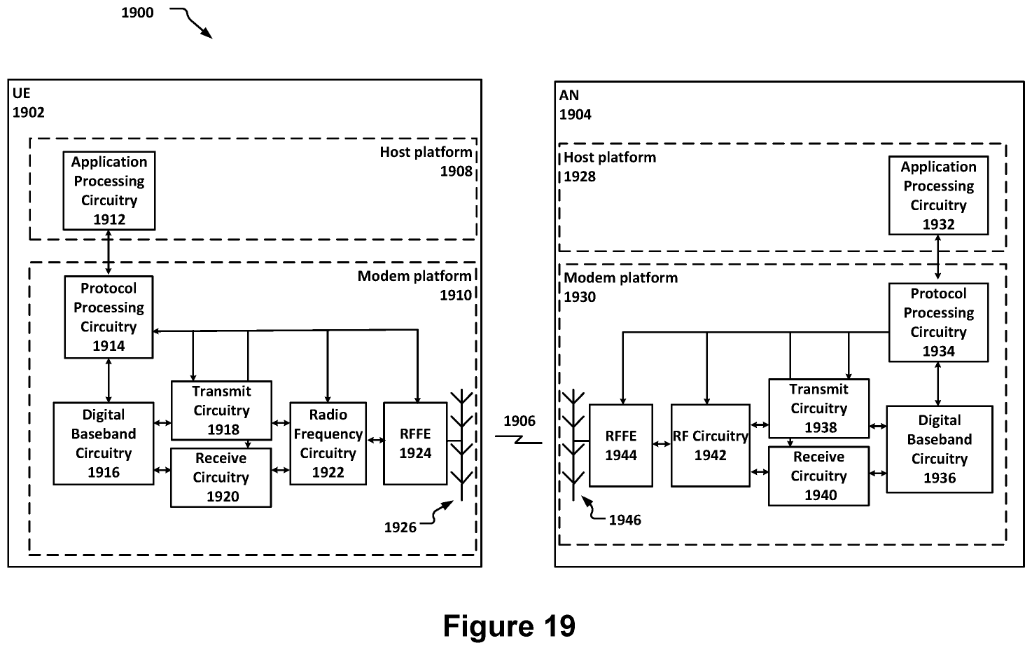

FIG. 19 schematically illustrates a wireless network 1900 in accordance with various embodiments. The wireless network 1900 may include a UE 1902 in wireless communication with an AN 1904. The UE 1902 and AN 1904 may be similar to, and substantially interchangeable with, like-named components described elsewhere herein.

The UE 1902 may be communicatively coupled with the AN 1904 via connection 1906. The connection 1906 is illustrated as an air interface to enable communicative coupling, and can be consistent with cellular communications protocols such as an LTE protocol or a 5G NR protocol operating at mmWave or sub-6 GHz frequencies.

The UE 1902 may include a host platform 1908 coupled with a modem platform 1910. The host platform 1908 may include application processing circuitry 1912, which may be coupled with protocol processing circuitry 1914 of the modem platform 1910. The application processing circuitry 1912 may run various applications for the UE 1902 that source/sink application data. The application processing circuitry 1912 may further implement one or more layer operations to transmit/receive application data to/from a data network. These layer operations may include transport (for example UDP) and Internet (for example, IP) operations

The protocol processing circuitry 1914 may implement one or more of layer operations to facilitate transmission or reception of data over the connection 1906. The layer operations implemented by the protocol processing circuitry 1914 may include, for example, MAC, RLC, PDCP, RRC and NAS operations.

The modem platform 1910 may further include digital baseband circuitry 1916 that may implement one or more layer operations that are “below” layer operations performed by the protocol processing circuitry 1914 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1910 may further include transmit circuitry 1918, receive circuitry 1920, RF circuitry 1922, and RF front end (RFFE) 1924, which may include or connect to one or more antenna panels 1926. Briefly, the transmit circuitry 1918 may include a digital-to-analog converter, mixer, intermediate frequency (IF) components, etc.; the receive circuitry 1920 may include an analog-to-digital converter, mixer, IF components, etc.; the RF circuitry 1922 may include a low-noise amplifier, a power amplifier, power tracking components, etc.; RFFE 1924 may include filters (for example, surface/bulk acoustic wave filters), switches, antenna tuners, beamforming components (for example, phase-array antenna components), etc. The selection and arrangement of the components of the transmit circuitry 1918, receive circuitry 1920, RF circuitry 1922, RFFE 1924, and antenna panels 1926 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1914 may include one or more instances of control circuitry (not shown) to provide control functions for the transmit/receive components.

A UE reception may be established by and via the antenna panels 1926, RFFE 1924, RF circuitry 1922, receive circuitry 1920, digital baseband circuitry 1916, and protocol processing circuitry 1914. In some embodiments, the antenna panels 1926 may receive a transmission from the AN 1904 by receive-beamforming signals received by a plurality of antennas/antenna elements of the one or more antenna panels 1926.

A UE transmission may be established by and via the protocol processing circuitry 1914, digital baseband circuitry 1916, transmit circuitry 1918, RF circuitry 1922, RFFE 1924, and antenna panels 1926. In some embodiments, the transmit components of the UE 1904 may apply a spatial filter to the data to be transmitted to form a transmit beam emitted by the antenna elements of the antenna panels 1926.

Similar to the UE 1902, the AN 1904 may include a host platform 1928 coupled with a modem platform 1930. The host platform 1928 may include application processing circuitry 1932 coupled with protocol processing circuitry 1934 of the modem platform 1930. The modem platform may further include digital baseband circuitry 1936, transmit circuitry 1938, receive circuitry 1940, RF circuitry 1942, RFFE circuitry 1944, and antenna panels 1946. The components of the AN 1904 may be similar to and substantially interchangeable with like-named components of the UE 1902. In addition to performing data transmission/reception as described above, the components of the AN 1908 may perform various logical functions that include, for example, RNC functions such as radio bearer management, uplink and downlink dynamic radio resource management, and data packet scheduling.

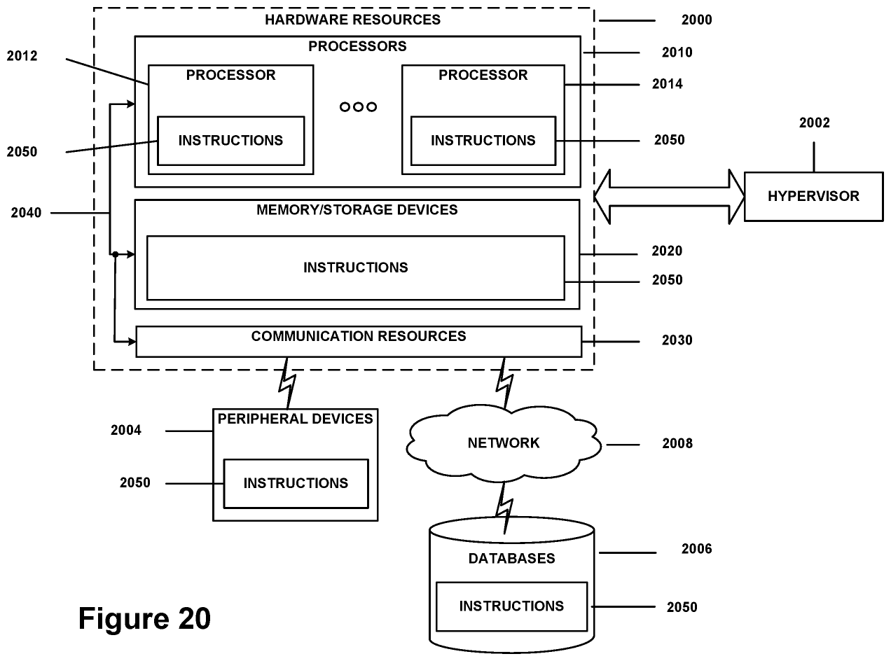

FIG. 20 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 20 shows a diagrammatic representation of hardware resources 2000 including one or more processors (or processor cores) 2010, one or more memory/storage devices 2020, and one or more communication resources 2030, each of which may be communicatively coupled via a bus 2040 or other interface circuitry. For embodiments where node virtualization (e.g., NFV) is utilized, a hypervisor 2002 may be executed to provide an execution environment for one or more network slices/sub-slices to utilize the hardware resources 2000.

The processors 2010 may include, for example, a processor 2012 and a processor 2014. The processors 2010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2020 may include main memory, disk storage, or any suitable combination thereof. The memory/storage devices 2020 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2030 may include interconnection or network interface controllers, components, or other suitable devices to communicate with one or more peripheral devices 2004 or one or more databases 2006 or other network elements via a network 2008. For example, the communication resources 2030 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2050 may comprise software, a program, an application, an applet, an app, or other executable code for causing at least any of the processors 2010 to perform any one or more of the methodologies discussed herein. The instructions 2050 may reside, completely or partially, within at least one of the processors 2010 (e.g., within the processor's cache memory), the memory/storage devices 2020, or any suitable combination thereof. Furthermore, any portion of the instructions 2050 may be transferred to the hardware resources 2000 from any combination of the peripheral devices 2004 or the databases 2006. Accordingly, the memory of processors 2010, the memory/storage devices 2020, the peripheral devices 2004, and the databases 2006 are examples of computer-readable and machine-readable media.

### Example Procedures

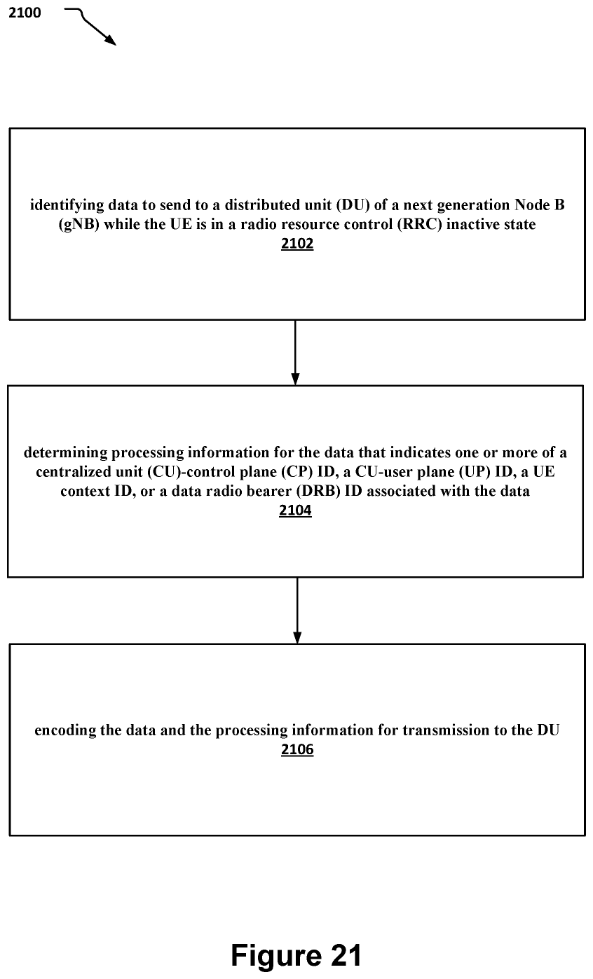

In some embodiments, the electronic device(s), network(s), system(s), chip(s) or component(s), or portions or implementations thereof, of FIGS. 18-20, or some other figure herein, may be configured to perform one or more processes, techniques, or methods as described herein, or portions thereof. For example, FIG. 21 illustrates a process 2100 in accordance with various embodiments. In some embodiments, the process 2100 may be performed by a UE or a portion thereof.

At 2102, the process 2100 may include identifying data to send to a distributed unit (DU) of a next generation Node B (gNB) while the UE is in a radio resource control (RRC) inactive state. At 2104, the process 2100 may further include determining processing information for the data that indicates one or more of a centralized unit (CU)-control plane (CP) ID, a CU-user plane (UP) ID, a UE context ID, or a data radio bearer (DRB) ID associated with the data. At 2106, the process 2100 may further include encoding the data and the processing information for transmission to the DU.

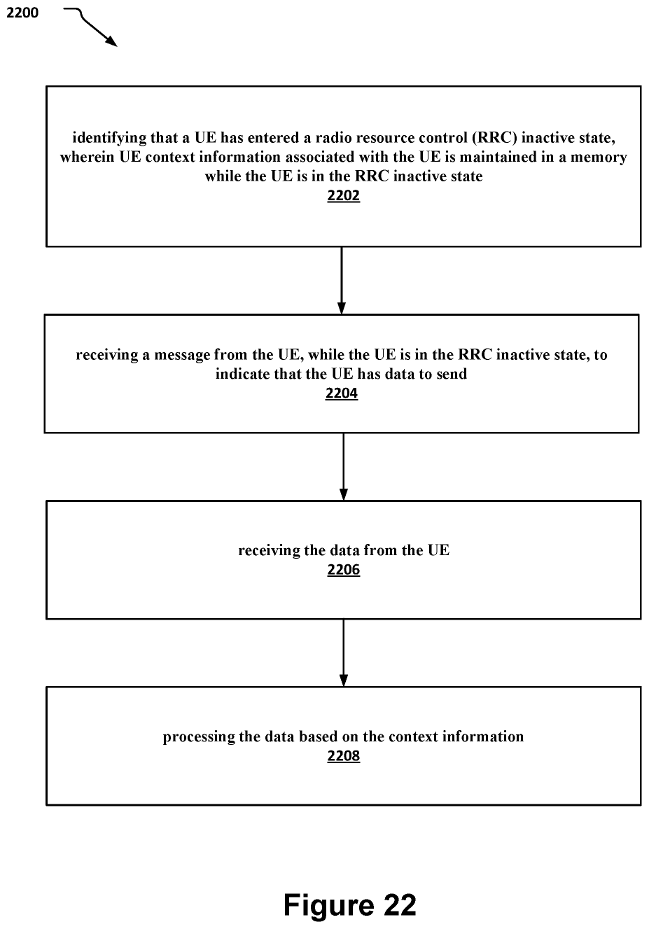

FIG. 22 illustrates another process 2200 in accordance with various embodiments. In some embodiments, the process 2200 may be performed by a DU of a gNB, or a portion thereof. At 2202, the process 2200 may include identifying that a UE has entered a radio resource control (RRC) inactive state, wherein UE context information associated with the UE is maintained in a memory while the UE is in the RRC inactive state. At 2204, the process 2200 may further include receiving a message from the UE, while the UE is in the RRC inactive state, to indicate that the UE has data to send. At 2206, the process 2200 may further include receiving the data from the UE. At 2208, the process 2200 may further include processing the data based on the context information. For example, the DU may retrieve the context information from the memory, and/or the context information may already be available to processor circuitry of the DU.

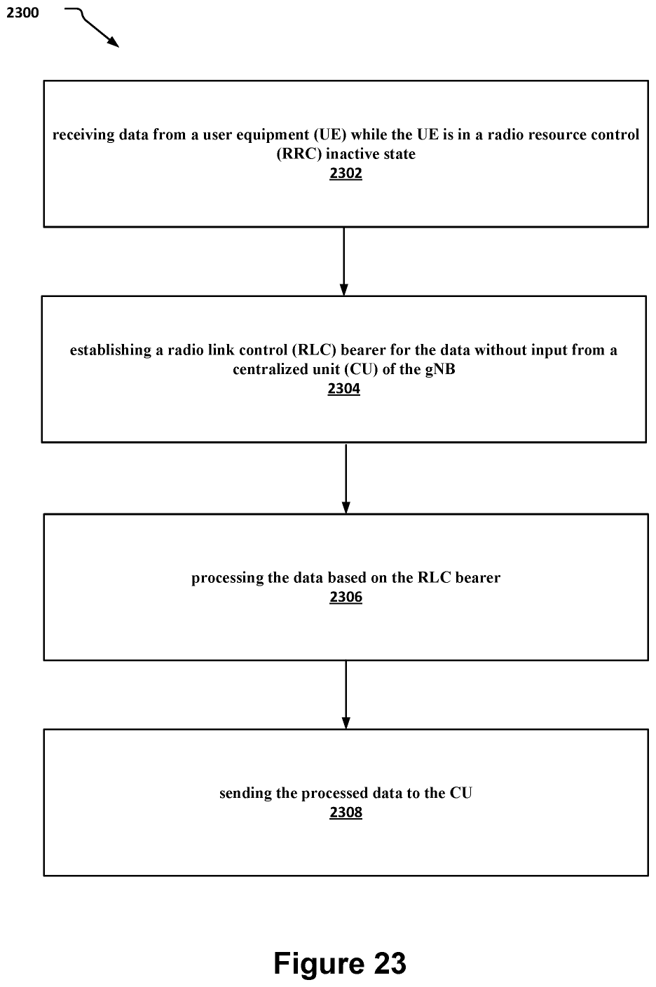

FIG. 23 illustrates another process 2300 in accordance with various embodiments. In some embodiments, the process 2300 may be performed by a DU of a gNB, or a portion thereof. At 2302, the process 2300 may include receiving data from a user equipment (UE) while the UE is in a radio resource control (RRC) inactive state. At 2304, the process 2300 may further include establishing a radio link control (RLC) bearer for the data without input from a centralized unit (CU) of the gNB. At 2306, the process 2300 may further include processing the data based on the RLC bearer. At 2308, the process 2300 may further include sending the processed data to the CU.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method for UE to send small volume of data to the network from a dormant state, the UE providing information to the network on how to process the data and where to send the data.

Example 2 may include where the system is 5G NR, and the dormant state is RRC_INACTIVE state.

Example 3 may include where the data may be sent in one packet or in separate subsequent packets over the radio.

Example 4 may include where the information provided to the network may compromise any of CU-CP ID, CU-UP ID, UE context ID, DRB ID.

Example 5 may include the method of example 3 or some other example herein, where the ID may be provided explicitly or as part of or implied by other IDs provided by the UE such as Resume ID, I-RNTI or logical channel ID.

Example 6 may include where the UE may use the last stored configuration for the RLC bearer associated with this UE or a configuration common for all UEs for the cell or UE may provide the configuration in used as part of the data.

Example 7 may include the method of example 5 or some other example herein, where the choice can be controlled by the network either using dedicated signaling or broadcast.

Example 8 may include where the information in example 5 or some other example herein, wherein may be provided in an RRC message or as part of the MAC CE or MAC header or data header.

Example 9 may include where the DU processing the data based on the configuration information applicable for the data, the configuration being the common configuration for all the UEs or based on information provided by the UE along with the data or based on the last stored configuration.

Example 10 may include where the DU may temporarily store the user data while it receives the configuration for the user data from the CU-CP and subsequently processes the user data.

Example 11 may include where the DU establishes a communication path with the CU-CP and CU-UP for the user signaling and data and to identify the user context corresponding DRB using the information provided by the UE and possibly additional information provided by the CU-CP.

Example 12 may include here the DU may also be send user data to the CU-CP and then CU-CP forwards user data between the CU-CP and CU-UP.

Example 13 may include where the CU-CP and CU-UP may establish a path to the CU-CP and CU-UP holding the user context for two way forwarding of messages and data using the information provided the UE.

Example 14 may include where the DU puts together the DL data and RRC release message based on end marker indication for the last data packet from the CU-CP or CU-UP.

Example 15 is a method for implementing a UE, the method comprising: determining data to send to a network from a dormant state, the data including information on processing the data and where to send the data; and encoding a signal that includes the data for transmission to the network.

Example 16 may include the method of example 15, or of any other example herein, wherein the UE and network are 5G NR.

Example 17 may include the method of example 15, or of any other example herein, wherein the dormant state is a RRC_INACTIVE state.

Example 18 may include the method of example 15, or of any other example herein, wherein the signal is transmitted in one packet.

Example 19 may include the method of example 15, or of any other example herein, wherein the signal is transmitted in separate subsequent packets.

Example 20 may include the method of example 15, wherein the data includes a selected one or more of: CU-CP ID, CU-UP ID, UE context ID, or DRB ID.

Example 21 may include the method of example 20, or of any other example herein, wherein the ID is provided explicitly, as part of, or implied by another ID provided by the UE.

Example 22 may include the method of example 21, or of any other example herein, wherein the another ID provided by the UE includes a selected one or more of: Resume ID, I-RNTI or logical channel ID.

Example 23 may include the method of example 15, or of any other example herein, further comprising identifying a configuration of the UE.

Example 24 may include the method example 23, or of any other example herein, wherein the configuration is a selected one or more of: a last stored configuration for a RLC bearer associated with the UE, a common configuration for all UEs of a cell, or s configuration provided by the UE with the data.

Example 25 may include the method of example 20-24, or of any other example herein, wherein the selection is controlled by the network using dedicated signaling or broadcast signaling.

Example 26 may include the method of example 20-25, or of any other example herein, further comprising: receiving a signal from the network; and performing the selection based upon the received signal.

Example 27 may include the method of example 26, or of any other example herein, wherein the received signal includes an RRC message, a MAC CE, a MAC header, and/or a data header.

Example 28 may be a method for implementing a DU, the method comprising: receiving, from a UE, a signal that includes data; processing the signal to identify the data; and processing the data, based on configuration information applicable for the data, wherein the configuration information is a selected one of: a common configuration for all UEs, based on information provided by the UE within the data, or based on a last stored configuration.

Example 29 may include the method of example 28, or of any other example herein, further comprising: receiving, from a CU-CP, a signal that includes a configuration for the user data; and processing the received signal to determine the configuration.

Example 30 may include the method of example 29, or of any other example herein, further comprising: establishing a communication path with the CU-CP and a CU-UP for user signaling and data; and identifying a user context corresponding DRB based on the configuration information.

Example 31 may include the method of example 30, or of any other example herein, wherein the user context corresponding DRB is based further on information provided by the UE or information provided by the CU-CP.

Example X1 may include one or more non-transitory, computer-readable media (NTCRM) having instructions, stored thereon, that when executed by one or more processors cause a user equipment (UE) to: identify data to send to a distributed unit (DU) of a next generation Node B (gNB) while the UE is in a radio resource control (RRC) inactive state; determine processing information for the data that indicates one or more of a centralized unit (CU)-control plane (CP) ID, a CU-user plane (UP) ID, a UE context ID, or a data radio bearer (DRB) ID associated with the data; and encode the data and the processing information for transmission to the DU.

Example X2 may include the one or more NTCRM of example X1, wherein the data and the processing information are transmitted in one packet.

Example X3 may include the one or more NTCRM of example X1, wherein the data and the processing information are included in separate packets.

Example X4 may include the one or more NTCRM of example X1, wherein the processing information includes the UE context ID to identify UE context information stored in the DU.

Example X5 may include the one or more NTCRM of example X1, wherein the processing information includes the CU-CP ID or the CU-UP ID.

Example X6 may include the one or more NTCRM of any of examples X1-X5, wherein the processing information is transmitted with a RRC resume request.

Example X7 may include the one or more NTCRM of any of examples X1-X6, wherein the processing information is included in a medium access control (MAC) control element (CE).

Example X8 may include the one or more NTCRM of example X1, wherein the processing information is determined based on a configuration of the UE, wherein the configuration is a last stored configuration for a radio link control (RLC) bearer associated with the UE, a common configuration for all UEs of a cell, or is provided by the UE with the data.

Example X9 may include an apparatus of a distributed unit of a next generation Node B (gNB), the apparatus comprising: a memory to store user equipment (UE) context information associated with a UE; and processor circuitry coupled to the memory. The processor circuitry is to: identify that the UE has entered a radio resource control (RRC) inactive state, wherein the UE context information is maintained in the memory while the UE is in the RRC inactive state; receive a message from the UE, while the UE is in the RRC inactive state, to indicate that the UE has data to send; receive the data from the UE; and process the data based on the context information.

Example X10 may include the apparatus of example X9, wherein the UE context information includes a radio link control (RLC) bearer instance, and wherein the data is processed using the RLC bearer instance.

Example X11 may include the apparatus of example X9, wherein the identification that the UE has entered the RRC inactive state is based on a UE context release command received from a centralized unit (CU) of the gNB, wherein the UE context release command includes an indication that the DU is to maintain the UE context information.

Example X12 may include the apparatus of example X9, wherein the message is a RRC resume request.

Example X13 may include the apparatus of example X9, wherein the message is a medium access control (MAC) control element (CE).

Example X14 may include the apparatus of example X9, wherein the processor circuitry is to multiplex downlink data with a RRC release message for transmission to the UE based on an end marker indication for a last data packet received from a centralized unit (CU)-control plane (CP) or a CU-user plane (UP).

Example X15 may include the apparatus of any of examples X10-X14, wherein the message includes a UE context identifier, and wherein the context information is retrieved based on the UE context identifier.

Example X16 may include one or more non-transitory, computer-readable media (NTCRM) having instructions, stored thereon, that when executed by one or more processors cause a distributed unit (DU) of a next generation Node B (gNB) to: receive data from a user equipment (UE) while the UE is in a radio resource control (RRC) inactive state; establish a radio link control (RLC) bearer for the data without input from a centralized unit (CU) of the gNB; process the data based on the RLC bearer; and send the processed data to the CU.

Example X17 may include the one or more NTCRM of example X16, wherein the RLC bearer is established using a default configuration.

Example X18 may include the one or more NTCRM of example X17, wherein the instructions, when executed, are further to cause the DU to receive, from the UE, an indication of a data radio bearer (DRB) and a CU-user plane (UP) identifier associated with the data.

Example X19 may include the one or more NTCRM of example X17, wherein the instructions, when executed, are further to cause the DU to receive a session ID associated with the data.

Example X20 may include the one or more NTCRM of example X16-X19, wherein the RLC bearer is established using a UE-specific configuration.

Example X21 may include the one or more NTCRM of example X20, wherein the instructions, when executed, are further to cause the DU to receive information for the UE-specific configuration from the UE.

Example X22 may include the one or more NTCRM of example X21, wherein the information includes one or more parameters of a prior RLC configuration or a prior medium access control (MAC) logical channel configuration of the UE.

Example Z01 may include an apparatus comprising means to perform one or more elements of a method described in or related to any of examples 1-31, X1-X22, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-31, X1-X22, or any other method or process described herein.

Example Z03 may include an apparatus comprising logic, modules, or circuitry to perform one or more elements of a method described in or related to any of examples 1-31, X1-X22, or any other method or process described herein.

Example Z04 may include a method, technique, or process as described in or related to any of examples 1-31, X1-X22, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-31, X1-X22, or portions thereof.

Example Z06 may include a signal as described in or related to any of examples 1-31, X1-X22, or portions or parts thereof. Example Z07 may include a datagram, packet, frame, segment, protocol data unit (PDU), or message as described in or related to any of examples 1-31, X1-X22, or portions or parts thereof, or otherwise described in the present disclosure.

Example Z08 may include a signal encoded with data as described in or related to any of examples 1-31, X1-X22, or portions or parts thereof, or otherwise described in the present disclosure.

Example Z09 may include a signal encoded with a datagram, packet, frame, segment, protocol data unit (PDU), or message as described in or related to any of examples 1-31, X1-X22, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-31, X1-X22, or portions thereof.

Example Z11 may include a computer program comprising instructions, wherein execution of the program by a processing element is to cause the processing element to carry out the method, techniques, or process as described in or related to any of examples 1-31, X1-X22, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
ACK Acknowledgement
AF Application Function
AM Acknowledged Mode
AMBR Aggregate Maximum Bit Rate
AMF Access and Mobility Management Function
AN Access Network
ANR Automatic Neighbour Relation
AP Application Protocol, Antenna Port,
Access Point
API Application Programming Interface
APN Access Point Name
ARP Allocation and Retention Priority
ARQ Automatic Repeat Request
AS Access Stratum
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary
Identity
CA Carrier Aggregation, Certification
Authority
CAPEX CAPital EXpenditure
CBRA Contention Based Random Access
CC Component Carrier, Country Code,
Cryptographic Checksum
CCA Clear Channel Assessment
CCE Control Channel Element
CCCH Common Control Channel
CE Coverage Enhancement
CDM Content Delivery Network
CDMA Code-Division Multiple Access
CFRA Contention Free Random Access
CG Cell Group
CI Cell Identity
CID Cell-ID (e.g., positioning method)
CIM Common Information Model
CIR Carrier to Interference Ratio
CK Cipher Key
CM Connection Management, Conditional
Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection
Point
CPD Connection Point Descriptor
CPE Customer Premise Equipment
CPICH Common Pilot Channel
CQI Channel Quality Indicator
CPU CSI processing unit, Central Processing
Unit
C/R Command/Response field bit
CRAN Cloud Radio Access Network, Cloud RAN
CRB Common Resource Block
CRC Cyclic Redundancy Check
CRI Channel-State Information Resource
Indicator, CSI-RS Resource Indicator
C-RNTI Cell RNTI
CS Circuit Switched
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference
ratio
CSMA Carrier Sense Multiple Access
CSMA/CA CSMA with collision avoidance
CSS Common Search Space, Cell-specific
Search Space
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DRB Data Radio Bearer
DRS Discovery Reference Signal
DRX Discontinuous Reception
DSL Domain Specific Language. Digital
Subscriber Line
DSLAM DSL Access Multiplexer
DwPTS Downlink Pilot Time Slot
E-LAN Ethernet Local Area Network
E2E End-to-End
ECCA extended clear channel assessment,
extended CCA
ECCE Enhanced Control Channel Element,
Enhanced CCE
ED Energy Detection
EDGE Enhanced Datarates for GSM Evolution
(GSM Evolution)
EGMF Exposure Governance Management Function
EGPRS Enhanced GPRS
EIR Equipment Identity Register
eLAA enhanced Licensed Assisted Access,
enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical
Downlink Control Cannel
EPRE Energy per resource element
EPS Evolved Packet System
EREG enhanced REG, enhanced resource
element groups
ETSI European Telecommunications
Standards Institute
ETWS Earthquake and Tsunami Warning System
eUICC embedded UICC, embedded Universal
Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMA Frequency Division Multiple Access
FE Front End
FEC Forward Error Correction
FFS For Further Study
FFT Fast Fourier Transformation
feLAA further enhanced Licensed Assisted Access,
further enhanced LAA
FN Frame Number
FPGA Field-Programmable Gate Array
FR Frequency Range
G-RNTI GERAN Radio Network Temporary Identity
GERAN GSM EDGE RAN, GSM EDGE Radio Access Network
GGSN Gateway GPRS Support Node
GLONASS GLObal'naya NAvigatsionnaya
Sputnikovaya Sistema (Engl.: Global Navigation
Satellite System)
gNB Next Generation NodeB
gNB-CU gNB-centralized unit, Next Generation
NodeB centralized unit
gNB-DU gNB-distributed unit, Next Generation
NodeB distributed unit
GNSS Global Navigation Satellite System
GPRS General Packet Radio Service
GSM Global System for Mobile Communications,
Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics
Engineers
IEI Information Element Identifier
IEIDL Information Element Identifier Data Length
IETF Internet Engineering Task Force
IF Infrastructure
IM Interference Measurement, Intermodulation,
IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN Constraint length of the
convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec
Tunnel
LTE Long Term Evolution
M2M Machine-to-Machine
MAC Medium Access Control (protocol layering context)
MAC Message authentication code (security/encryption
context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service Single
Frequency Network
MCC Mobile Country Code
MCG Master Cell Group
MCOT Maximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information
Base
MIMO Multiple Input Multiple Output
MLC Mobile Location Centre
MM Mobility Management
MME Mobility Management Entity
MN Master Node
MnS Management Service
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information, MCH Scheduling
Information
MSID Mobile Station Identifier
MSIN Mobile Station Identification Number
MSISDN Mobile Subscriber ISDN Number
MT Mobile Terminated, Mobile Termination
MTC Machine-Type Communications
mMTC massive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non-Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAI Network Slice Selection Assistance Information
S-NNSAI Single-NSSAI
NSSF Network Slice Selection Function
NW Network
NWUS Narrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol, Packet
Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSFCH Physical Sidelink Feedback Channel
PSSCH Physical Sidelink Shared Channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quaternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System
Information
RN Relay Node
RNC Radio Network Controller
RNL Radio Network Layer
RNTI Radio Network Temporary Identifier
ROHC RObust Header Compression
RRC Radio Resource Control, Radio Resource
Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SC-FDMA Single Carrier Frequency Division
Multiple Access
SCG Secondary Cell Group
SCM Security Context Management
SCS Subcarrier Spacing
SCTP Stream Control Transmission Protocol
SDAP Service Data Adaptation Protocol, Service Data
Adaptation Protocol layer
SDL Supplementary Downlink
SDNF Structured Data Storage Network Function
SDP Session Description Protocol
SDSF Structured Data Storage Function
SDU Service Data Unit
SEAF Security Anchor Function
SeNB secondary eNB
SEPP Security Edge Protection Proxy
SFI Slot format indication
SFTD Space-Frequency Time Diversity, SFN and
frame timing difference
SFN System Frame Number or Single Frequency Network
SgNB Secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTI Semi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB SS Block
SSBRI SSB Resource Indicator
SSC Session and Service Continuity
SS-RSRP Synchronization Signal based Reference
Signal Received Power
SS-RSRQ Synchronization Signal based Reference
Signal Received Quality
SS-SINR Synchronization Signal based Signal to
Noise and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
UDR Unified Data Repository
UDSF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over-Internet Protocol
VPLMN Visited Public Land Mobile Network
VPN Virtual Private Network
VRB Virtual Resource Block
WiMAX Worldwide Interoperability for Microwave
Access
WLAN Wireless Local Area Network
WMAN Wireless Metropolitan Area Network
WPAN Wireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.
The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”
The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.
The term “user equipment” or “UE” as used herein refers to a device with radio communication capabilities and may describe a remote user of network resources in a communications network.
The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.
The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.
The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.
The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.
The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc.
The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.
The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.
The terms “instantiate,” “instantiation,” and the like as used herein refers to the creation of an instance. An “instance” also refers to a concrete occurrence of an object, which may occur, for example, during execution of program code.
The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another.
The term “communicatively coupled” may mean that two or more elements may be in contact with one another by a means of communication including through a wire or other interconnect connection, through a wireless communication channel or link, and/or the like.
The term “information element” refers to a structural element containing one or more fields. The term “field” refers to individual contents of an information element, or a data element that contains content.
The term “SMTC” refers to an SSB-based measurement timing configuration configured by SSB-MeasurementTimingConfiguration.
The term “SSB” refers to an SS/PBCH block.
The term “a “Primary Cell” refers to the MCG cell, operating on the primary frequency, in which the UE either performs the initial connection establishment procedure or initiates the connection re-establishment procedure.
The term “Primary SCG Cell” refers to the SCG cell in which the UE performs random access when performing the Reconfiguration with Sync procedure for DC operation.
The term “Secondary Cell” refers to a cell providing additional radio resources on top of a Special Cell for a UE configured with CA.
The term “Secondary Cell Group” refers to the subset of serving cells comprising the PSCell and zero or more secondary cells for a UE configured with DC.
The term “Serving Cell” refers to the primary cell for a UE in RRC_CONNECTED not configured with CA/DC there is only one serving cell comprising of the primary cell.
The term “serving cell” or “serving cells” refers to the set of cells comprising the Special Cell(s) and all secondary cells for a UE in RRC_CONNECTED configured with CA/.
The term “Special Cell” refers to the PCell of the MCG or the PSCell of the SCG for DC operation; otherwise, the term “Special Cell” refers to the Pcell.

1-22. (canceled)

23. One or more non-transitory, computer-readable media (NTCRM) having instructions, stored thereon, that when executed by one or more processors cause a user equipment (UE) to:
identify data to send to a distributed unit (DU) of a next generation Node B (gNB) while the UE is in a radio resource control (RRC) inactive state;
determine processing information for the data that indicates one or more of a centralized unit (CU)-control plane (CP) ID, a CU-user plane (UP) ID, a UE context ID, or a data radio bearer (DRB) ID associated with the data; and
encode the data and the processing information for transmission to the DU.

24. The one or more NTCRM of claim 23, wherein the data and the processing information are transmitted in one packet.

25. The one or more NTCRM of claim 23, wherein the data and the processing information are included in separate packets.

26. The one or more NTCRM of claim 23, wherein the processing information includes the UE context ID to identify UE context information stored in the DU.

27. The one or more NTCRM of claim 23, wherein the processing information includes the CU-CP ID or the CU-UP ID.

28. The one or more NTCRM of claim 23, wherein the processing information is transmitted with a RRC resume request.

29. The one or more NTCRM of claim 23, wherein the processing information is included in a medium access control (MAC) control element (CE).

30. The one or more NTCRM of claim 23, wherein the processing information is determined based on a configuration of the UE, wherein the configuration is a last stored configuration for a radio link control (RLC) bearer associated with the UE, a common configuration for all UEs of a cell, or is provided by the UE with the data.

31. An apparatus of a distributed unit of a next generation Node B (gNB), the apparatus comprising:
a memory to store user equipment (UE) context information associated with a UE;
processor circuitry coupled to the memory, the processor circuitry to:
identify that the UE has entered a radio resource control (RRC) inactive state, wherein the UE context information is maintained in the memory while the UE is in the RRC inactive state;
receive a message from the UE, while the UE is in the RRC inactive state, to indicate that the UE has data to send;
receive the data from the UE; and
process the data based on the context information.

32. The apparatus of claim 31, wherein the UE context information includes a radio link control (RLC) bearer instance, and wherein the data is processed using the RLC bearer instance.

33. The apparatus of claim 31, wherein the identification that the UE has entered the RRC inactive state is based on a UE context release command received from a centralized unit (CU) of the gNB, wherein the UE context release command includes an indication that the DU is to maintain the UE context information.

34. The apparatus of claim 31, wherein the message is a RRC resume request.

35. The apparatus of claim 31, wherein the message is a medium access control (MAC) control element (CE).

36. The apparatus of claim 31, wherein the processor circuitry is to multiplex downlink data with a RRC release message for transmission to the UE based on an end marker indication for a last data packet received from a centralized unit (CU)-control plane (CP) or a CU-user plane (UP).

37. The apparatus of claim 31, wherein the message includes a UE context identifier, and wherein the context information is retrieved based on the UE context identifier.

38. One or more non-transitory, computer-readable media (NTCRM) having instructions, stored thereon, that when executed by one or more processors cause a distributed unit (DU) of a next generation Node B (gNB) to:
receive data from a user equipment (UE) while the UE is in a radio resource control (RRC) inactive state;
establish a radio link control (RLC) bearer for the data without input from a centralized unit (CU) of the gNB;
process the data based on the RLC bearer; and
send the processed data to the CU.

39. The one or more NTCRM of claim 38, wherein the RLC bearer is established using a default configuration.

40. The one or more NTCRM of claim 39, wherein the instructions, when executed, are further to cause the DU to receive, from the UE, an indication of a data radio bearer (DRB) and a CU-user plane (UP) identifier associated with the data.

41. The one or more NTCRM of claim 39, wherein the instructions, when executed, are further to cause the DU to receive a session ID associated with the data.

42. The one or more NTCRM of claim 38, wherein the RLC bearer is established using a UE-specific configuration.

43. The one or more NTCRM of claim 42, wherein the instructions, when executed, are further to cause the DU to receive information for the UE-specific configuration from the UE.

44. The one or more NTCRM of claim 43, wherein the information includes one or more parameters of a prior RLC configuration or a prior medium access control (MAC) logical channel configuration of the UE.
